(19) United States
(12) Patent Application Publication
(10) Pub. No.: US 2023/0029652 A1
(43) Pub. Date: Feb. 2, 2023

(54) LEARNING-ROOTED IOT PLATFORM

(71) Applicant: University of Florida Research Foundation, Incorporated, Gainesville, FL (US)

(72) Inventors: Swarup Bhunia, Gainesville, FL (US); Reiner Dizon, Gainesville, FL (US); Prabuddha Chakraborty, Gainesville, FL (US); Rohan Reddy Kalavakonda, Gainesville, FL (US); Parker Difuntorum, Gainesville, FL (US)

(21) Appl. No.: 17/863,172

(22) Filed: Jul. 12, 2022

Related U.S. Application Data
(60) Provisional application No. 63/221,832, filed on Jul. 14, 2021.

(51) Int. Cl. G06F 1/16; G06F 1/18; G06N 20/00

(52) U.S. Cl. CPC G06F 1/163; G06F 1/181; G06F 1/189; G06N 20/00

(57) ABSTRACT

Embodiments provide for a learning-rooted IoT platform. In example embodiments, a plug-and-play base pad apparatus includes one or more ports, each configured for hosting a pluggable component. The plug-and-play base pad apparatus further includes one or more of an administration chip or a microcontroller configured to control the apparatus and the one or more ports. The plug-and-play base pad apparatus further includes a battery configured to power the apparatus. The plug-and-play base pad apparatus further includes a power management unit configured to monitor the battery and interface with charging mechanisms.

### CROSS-REFERENCE TO RELATED APPLICATIONS

The present application claims priority to U.S. Provisional Application Ser. No. 63/221,832, titled “LEARNING-ROOTED IOT PLATFORM,” filed Jul. 14, 2021, the contents of which are incorporated herein by reference in their entirety.

### BACKGROUND

In recent years, rapid adoption and development of pre-configured Internet of Things (IoT) systems and wearables have coincided with the growth of their corresponding consumer market sectors. Akin to smartphones, the IoT systems that are developed for these markets are often sold as a complete system with little to no reconfigurability available to the end user. In other words, if the user wants to customize the components of their IoT system, they either need to buy expensive upgrades with other unnecessary parts or upgrade the entire system, both of which can be expensive for the end user. Users are often forced to upgrade the entire system regardless due to poor lifetime system performance or force throttling of their system by software as companies phase them out. Both issues are part of a phenomenon called planned obsolescence. In addition, during the design process of a traditional system, artificial intelligence (AI) models and parameters are determined only after the hardware and/or software specifications of the system are finalized. This leads to poor optimization in-terms of AI usage. State-of-the-art applications are increasingly reliant on AI and, accordingly, an AI-rooted system designing paradigm is essential for such applications.

### BRIEF SUMMARY

Embodiments provide for a learning-rooted IoT platform. In example embodiments, a plug-and-play base pad apparatus includes one or more ports, each configured for hosting a pluggable component. The plug-and-play base pad apparatus further includes one or more of an administration chip or a microcontroller configured to control the apparatus and the one or more ports. The plug-and-play base pad apparatus further includes a battery configured to power the apparatus. The plug-and-play base pad apparatus further includes a power management unit configured to monitor the battery and interface with charging mechanisms.

### BRIEF DESCRIPTION OF THE DRAWINGS

Having thus described the invention in general terms, reference will now be made to the accompanying drawings, which are not necessarily drawn to scale, and wherein:

FIG. 1 provides an example overview of an architecture that can be used to practice embodiments of the present invention.

FIG. 2 provides an example learning-rooted IoT computing entity in accordance with some embodiments discussed herein.

FIG. 3 provides an example client computing entity in accordance with some embodiments discussed herein.

FIG. 4 depicts an example platform for use with embodiments of the present disclosure.

FIG. 5 depicts an example base pad for use with embodiments of the present disclosure.

FIG. 6 depicts an example base pad for use with embodiments of the present disclosure.

FIG. 7A depicts a cross-sectional view of three layers of an example base pad, in accordance with embodiments of the present disclosure.

FIG. 7B depicts a cross-sectional view of conductive traces of an example base pad, in accordance with embodiments of the present disclosure.

FIG. 7C depicts a pluggable device circuit and its cross-sectional view, in accordance with embodiments of the present disclosure.

FIG. 7D depicts a cross-sectional view of sliding guide rails for aligning a pluggable device onto an example base pad, in accordance with embodiments of the present disclosure.

FIG. 8 depicts an example circuit diagram template for pluggable components, for use with embodiments of the present disclosure.

FIG. 9 depicts an example administration (e.g., admin) chip for use with embodiments of the present disclosure.

FIG. 10A depicts an example microcontroller slot within an example base pad, for use with embodiments of the present disclosure.

FIG. 10B depicts an example pluggable slot within an example base pad, for use with embodiments of the present disclosure.

FIG. 11 depicts an example power management unit for use with an example base pad, according to embodiments of the present disclosure.

FIG. 12A depicts an example wired charging interface, for use with embodiments of the present disclosure.

FIG. 12B depicts an example wireless charging interface, for use with embodiments of the present disclosure.

FIG. 13 depicts an example system design process.

FIG. 14 depicts an example system design process for use with embodiments of the present disclosure.

FIG. 15 depicts an example design procedure for a single learning-rooted IoT platform, in accordance with embodiments of the present disclosure.

FIG. 16 depicts an example power-up initialization, for use with embodiments of the present disclosure.

FIG. 17 depicts an example communication initialization, for use with embodiments of the present disclosure.

FIG. 18 depicts example wireless communication among components of an example learning-rooted IoT platform, according to embodiments of the present disclosure.

FIG. 19 depicts wirelessly networked learning-rooted IoT platforms, according to embodiments of the present disclosure.

FIG. 20 depicts self-aware integration capabilities of example learning-rooted IoT platforms, according to embodiments of the present disclosure.

FIG. 21 depicts example integration among learning-rooted IoT platforms, according to embodiments of the present disclosure.

FIG. 22 depicts example security among learning-rooted IoT platforms, according to embodiments of the present disclosure.

FIGS. 23, 24, and 25 depict example operations for use in accordance with embodiments of the present disclosure.

FIG. 26 depicts example security among learning-rooted IoT platforms, according to embodiments of the present disclosure.

FIG. 27 depicts an example use case for deploying IoT devices in a remotely inconvenient location, according to embodiments of the present disclosure.

FIG. 28 depicts an example of the monitoring and diagnosis use case in automobiles and appliances, in accordance with embodiments of the present disclosure.

FIG. 29 depicts an example smart fitness device configured in accordance with embodiments of the present disclosure.

FIGS. 30A and 30B depict monitoring using an example smart fitness device configured in accordance with embodiments of the present disclosure.

FIG. 31 depicts a 3-dimensional (3D) view of a device configured in accordance with embodiments of the present disclosure.

FIG. 32 depicts various use cases for a reconfigurable smart body patch in accordance with embodiments of the present disclosure.

FIG. 33 depicts an example hardware platform of a reconfigurable smart body patch accordance with embodiments of the present disclosure.

FIG. 34 depicts example components with uniform interfaces (CUI) of an example hardware platform of a reconfigurable smart body patch accordance with embodiments of the present disclosure.

FIG. 35 depicts an example designing framework of a reconfigurable smart body patch accordance with embodiments of the present disclosure.

FIG. 36 depicts an example base pad and peripheral device circuit of an example reconfigurable smart body patch accordance with embodiments of the present disclosure.

FIGS. 37, 38, 39, and 40 depict example operations for use in accordance with embodiments of the present disclosure.

FIGS. 41A, 41B, and 41C depict example reconfigurable smart body patches accordance with embodiments of the present disclosure.

FIG. 42 depicts an example reconfigurable smart body patches accordance with embodiments of the present disclosure.

FIGS. 43A, 43B, 43C, 43D, 43E, 43F, 43G, and 43H depict sensor data collected using example reconfigurable smart body patches accordance with embodiments of the present disclosure.

FIG. 44 depicts posture correctness detection using an example reconfigurable smart body patch accordance with embodiments of the present disclosure.

### DETAILED DESCRIPTION

Various embodiments of the present invention now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Overview and Technical Improvements

Conventionally, IoT products are sold as an all-in-one system that offers little to no customizability options to the end user. When it is time to upgrade, change, or repair a component of the system, the end user has to purchase a full replacement (e.g., complete) system with the desired components. To enable users of these technologies, there is a need for a flexible, portable IoT platform in which the users can customize their IoT devices with electronic parts that plugs into this platform.

Embodiments herein relate to a portable and reconfigurable platform (e.g., a base pad) which hosts electronic components that can be plugged into the platform (e.g., base pad) for creating custom application-specific IoT systems. Embodiments herein further describe systems, methods, and operations associated with designing, configuring, re-configuring, integrating, and operating custom application-specific IoT platforms or systems designed using the described base pad.

The present learning-rooted IoT platform enables plug-and-play, removable, and customizable IoT devices. This allows the end user to configure IoT systems for any desired application. These plug-and-play or “pluggable” hardware components are hosted in a circuit base pad which has guide rails for alignment. In one embodiment, the components and the base pad can be made of multiple layers (e.g., a conductive layer and a polymer layer). A solid state battery managed by a power management unit (PMU) can power the entire platform.

Components of the present system can be reused by the end user and can be swapped out as their intended application changes. In addition, an administration (Admin) chip handles the initial management of these components during first use and/or new installation of components.

Embodiments herein further provide for a learning-rooted and learning-centric system/platform designing methodology for building a custom application specific IoT device using the present framework. A learning-based guidance framework for system designing is also presented. Embodiments herein may include self-awareness features, such as intra- and inter-communication, component integration, and security. These capabilities enable self-sufficient management of the platforms without burdening the end user with manual administration of each platform.

### II. Exemplary Definitions

As used herein, the term “UFLIP” may refer to example embodiments directed to a learning rooted IoT platform. A “UFLIP platform” or “learning rooted IoT platform” may refer to one instance of an example base pad with installed pluggable components.

As used herein, a “UFLIP system,” “learning rooted IoT system,” “UFLIP local network,” “learning rooted IoT network” may refer to a group of nearby connected learning rooted IoT platforms that are connected wirelessly to perform an intended application.

As used herein, “pluggables,” or “pluggable components” may refer to plug-and-play hardware components that connects to a base pad. For example, a pluggable may include a power management unit, a microcontroller, an admin chip, and/or peripheral I/O components.

As used herein, “pluggable devices” may refer to plug-and-play peripheral I/O components. For example, pluggable devices may include sensors, actuators, transducers, and/or communication modules.

As used herein, “IoT” refers to Internet of Things. The Internet of things (IoT) describes a network of physical objects (e.g., “things”) that may be embedded with sensors, software, and other technologies for the purpose of connecting and exchanging data with other devices and systems over the Internet (e.g., or other communications network).

As used herein, “PMU” refers to a power management unit. For example, a power management unit may handle monitoring and charging tasks for a connected battery.

As used herein, “μC” refers to a microcontroller (e.g., or micro-controller).

### III. Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. Exemplary System Architecture

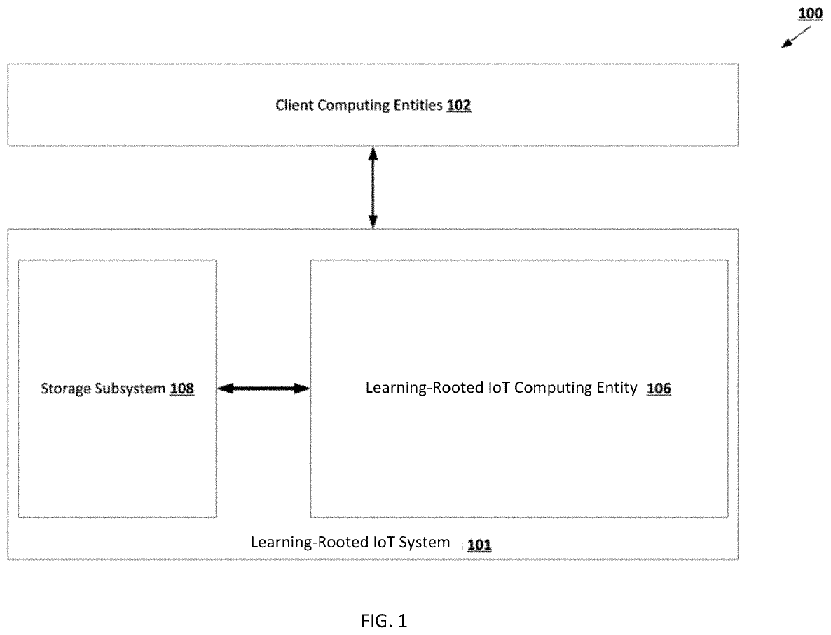

FIG. 1 is a schematic diagram of an example architecture 100 for use with embodiments herein. The architecture 100 includes a learning-rooted IoT system 101 configured to receive requests from client computing entities 102, process the requests, and provide the responses to the client computing entities 102. In some embodiments, learning-rooted IoT system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The learning-rooted IoT system 101 may include a learning-rooted IoT computing entity 106 and a storage subsystem 108. The storage subsystem 108 may be configured to store input data used by the learning-rooted IoT computing entity 106 to perform analyses data used by the learning-rooted IoT computing entity 106 to perform various tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Learning Rooted IoT Computing Entity

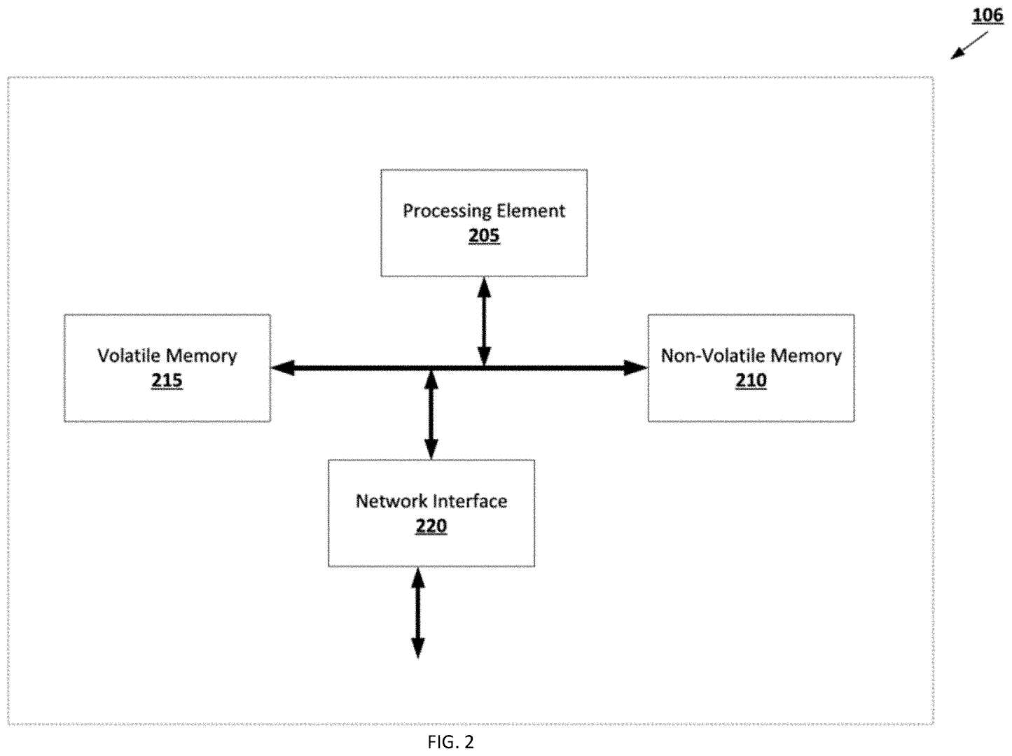

FIG. 2 provides a schematic of a learning-rooted IoT computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the learning-rooted IoT computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the learning-rooted IoT computing entity 106 may include, or be in communication with, one or more processing elements 205 (also referred to as processors, processing circuitry, and/or similar terms used herein interchangeably) that communicate with other elements within the learning-rooted IoT computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the learning-rooted IoT computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the learning-rooted IoT computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the learning-rooted IoT computing entity 106 with the assistance of the processing element 205 and operating system.

As indicated, in one embodiment, the learning-rooted IoT computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the learning-rooted IoT computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the learning-rooted IoT computing entity 106 may include, or be in communication with, one or more input elements, such as a keyboard input, a mouse input, a touch screen/display input, motion input, movement input, audio input, pointing device input, joystick input, keypad input, and/or the like. The learning-rooted IoT computing entity 106 may also include, or be in communication with, one or more output elements (not shown), such as audio output, video output, screen/display output, motion output, movement output, and/or the like.

### Exemplary Client Computing Entity

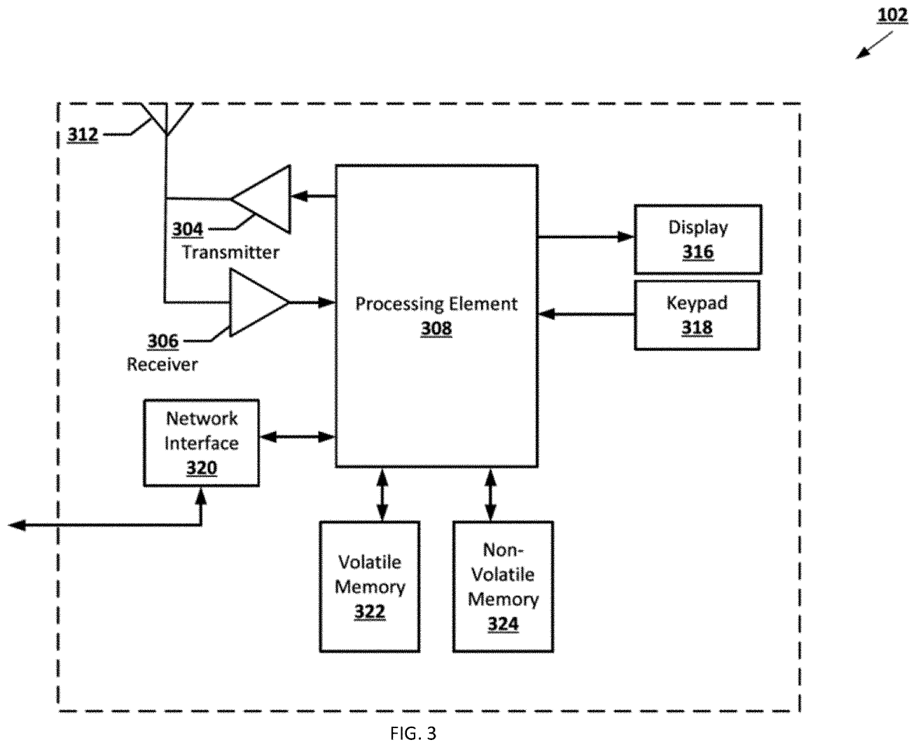

FIG. 3 provides an illustrative schematic representative of a client computing entity 102 (e.g., IoT component or device) that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the learning-rooted IoT computing entity 106. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the learning-rooted IoT computing entity 106 via a network interface 320.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the learning-rooted IoT computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the learning-rooted IoT computing entity 106 and/or various other computing entities.

In another embodiment, the client computing entity 102 may include one or more components or functionality that are the same or similar to those of the learning-rooted IoT computing entity 106, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. Exemplary System Operations

As described below, various embodiments of the present invention provide methods, apparatus, systems, computing devices, computing entities, and/or the like for a learning-rooted IoT platform. In example embodiments, a plug-and-play base pad apparatus includes one or more ports, each configured for hosting a pluggable component. The plug-and-play base pad apparatus further includes one or more of an administration chip or a microcontroller configured to control the apparatus and the one or more ports. The plug-and-play base pad apparatus further includes a battery configured to power the apparatus. The plug-and-play base pad apparatus further includes a power management unit configured to monitor the battery and interface with charging mechanisms.

FIG. 4 depicts an example platform for use with embodiments of the present disclosure. An example platform according to embodiments herein include a base pad 402 that can host electronic components that plug into the pad for creating custom application-specific IoT devices. In one embodiment, the base pad 402 can be made of a flexible circuit substrate that contains plug-and-play connection points for desired peripheral I/O components (e.g., pluggable components). These components may be contained in a miniaturized version of the base pad 402, which plugs into the base pad 402. A flexible and energy-dense solid-state battery can provide the power of the system while keeping a small form factor of this platform. The pluggable components can include a microcontroller, its connected storage device, an administration (e.g., or admin) chip, and a power management unit (PMU). The reconfigurability of this platform comes from the addition of extra slots for peripheral devices, called “pluggable” devices, such as sensors, actuators, and communication modules. Self-awareness communication, components/platforms integration, and security extends the reconfigurable of this proposed platform, which make the system self-sufficient and secure. Embodiments herein may utilize a learning-rooted system designing paradigm ideal for state-of-the-art AI-centric applications.

The base pad 402 is a reconfigurable and portable platform for connecting plug-and-play electronic components, such as Internet of Things (IoT) sensors, by plugging them into the platform that is configured based on a user's intended application. Embodiments herein provide a platform where the end user can create a Do-It-Yourself (DIY) IoT device for their intended application by choosing customized pluggable components.

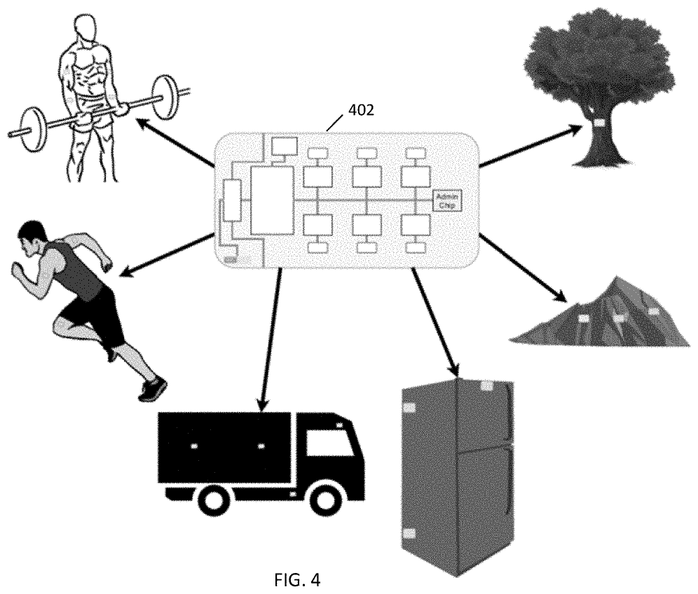

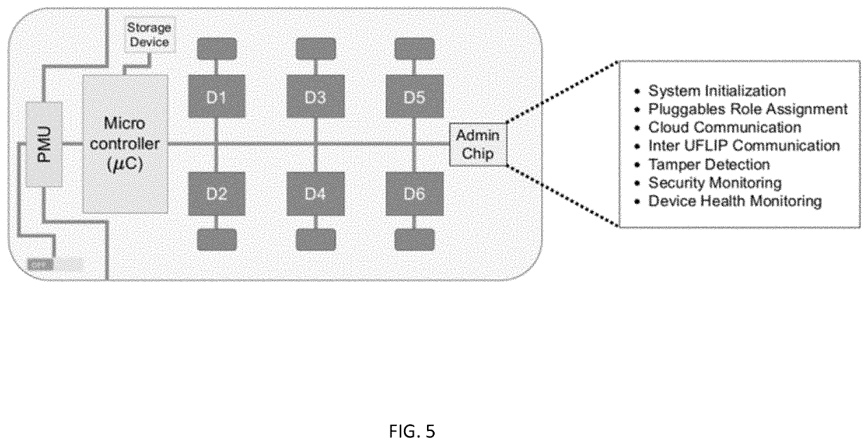

FIG. 5 depicts an example base pad for use with embodiments of the present disclosure. The base pad is reusable and flexible, and configured to interface with different pluggable components, such as microcontroller (μC), power management unit (PMU), and peripheral I/O components (D1-D6). While the microcontroller handles computing, communication, and data collection/fusion among all the connected devices on the platform, the administration (e.g., Admin) chip is responsible for initializing the system, as-signing roles to the pluggable components, and other roles explained in later sections.

Pluggable devices or peripheral I/O components can include, for example, sensors, actuators, transducers, communication modules, and any other compatible computing devices. The linear, block style configuration for connecting pluggable devices to the base pad allows for them to be inserted in one or more blocks to use more connection lines. In addition, this platform is powered using a thin solid-state battery underneath this substrate. Due to the heterogeneous nature of these devices, the admin chip and the microcontroller in this platform have mechanisms to initialize and configure the recently connected pluggable component, respectively. This self-aware integration abstracts away low-level software implementation from the end user, who only needs to install the desired pluggables. Besides this capability, the base pad includes security measures to detect maliciously inserted components and isolate them from the rest of the platform. The self-aware communication among the components underpins these two capabilities within a learning-rooted IoT platform as described herein as well as among a network of learning-rooted IoT platforms.

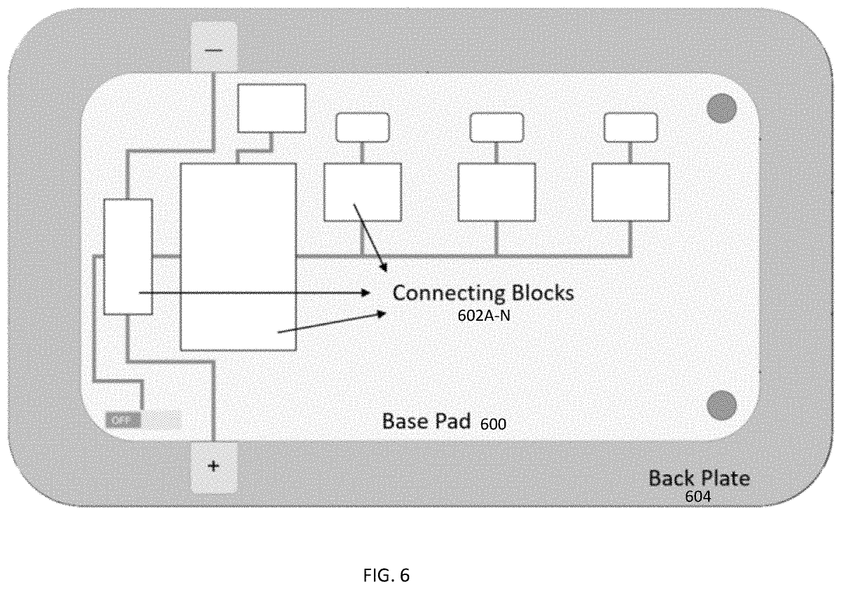

FIG. 6 depicts an example base pad for use with embodiments of the present disclosure. The base pad 600 of FIG. 6 includes provisions for each connecting block (e.g., of multiple connecting blocks 602A-N) to be replaced separately. In addition, the base pad 600 sits on a back plate 604 which can be adapted to a given requirement, enabling the device 600 to be mounted on any surface. The back plate 604 also acts as a structural support holding the base pad 600. The pluggable components with their corresponding connecting blocks (e.g., 602A-N) may be divided into the following groups:
Administration (Admin) Chip
Microcontroller (μC) and Storage Device
Pluggable Devices or Peripheral I/O Components
   a. Sensors
   b. Actuators
   c. Communication Modules
Power Management Unit (PMU)
Solid-State Battery and Charging Interface

The connecting blocks (e.g., 602A-N) for the pluggable components are removable and upgradeable. This makes the entire platform reconfigurable and allows the user to modify or update the platform to suite an application without needing to replace the complete platform. The connecting blocks (e.g., 602A-N) on the base pad 600 are all linked through a bus. The bus connects the microcontroller, storage device and the pluggable devices. The bus also transfers data and power between the connected modules. The PMU takes care of the power requirements for all the connected modules.

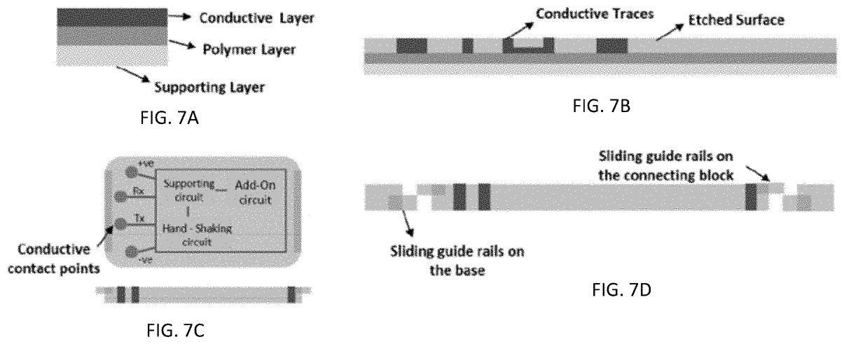

FIG. 7A depicts a cross-sectional view of three layers of an example base pad, in accordance with embodiments of the present disclosure. FIG. 7B depicts a cross-sectional view of conductive traces of an example base pad, in accordance with embodiments of the present disclosure. FIG. 7C depicts a pluggable device circuit and its cross-sectional view, in accordance with embodiments of the present disclosure. FIG. 7D depicts a cross-sectional view of sliding guide rails for aligning a pluggable device onto an example base pad, in accordance with embodiments of the present disclosure.

According to one embodiment, the composition of the printed circuit board (PCB) used as base pad shown in FIG. 7A. The connecting modules for the pluggable components also share this PCB composition, where further development is dictated by the end user's intended application. The PCB can include a supporting layer below the polymer layer, which provides additional structure to the pluggables and the conductive traces. To allow the entire platform to be flexible, the supporting layer and the polymer layer both with less rigid materials, such as foam for the supporting layer and polyimide for the polymer layer. The top layer is made from a conductive material, and when etched, it creates conductive traces in the PCB. The cross-sectional view of an etched surface is shown in FIG. 7B. Electrical components then can be mounted on to the PCB are placed along the routed conductive traces.

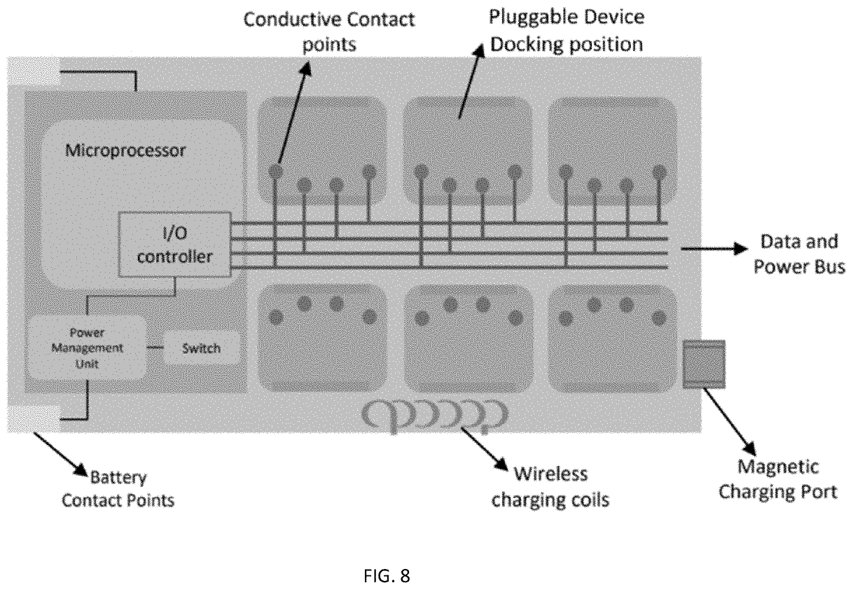

FIG. 8 depicts an example circuit diagram template for pluggable components, for use with embodiments of the present disclosure. FIG. 8 shows a circuit diagram of the electrical connections among all the connecting modules for the pluggable components on the base pad. Depending on the intended application, the end user can arrange the spaces for the connecting modules correspondingly. The micro-controller, storage device, and the power management unit are placed separately from the pluggable devices. The battery and the charging interface are also placed separately to help isolate them electrically. Isolating these sections based on their electrical connections helps with creating a modular platform. While there are six peripheral device slots in FIG. 8, the platform can accommodate as little as one and over six, depending on the requirement of the design. The end user can easily install and uninstall these pluggables to and from the platform.

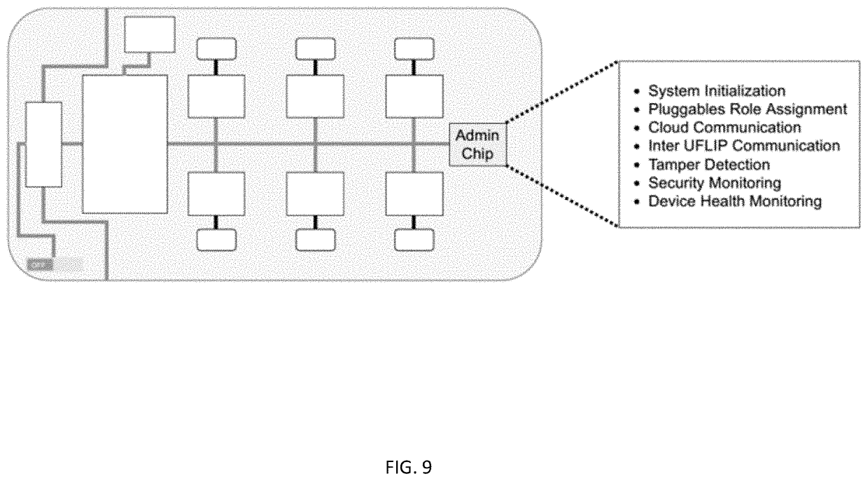

FIG. 9 depicts an example administration (e.g., admin) chip for use with embodiments of the present disclosure. The administration (e.g., admin) chip is a specially programmed microcontroller that handles the initialization of the components and communication among them. FIG. 9 highlights the admin chip in the platform (e.g., base pad) with empty slots. This admin chip may be pre-installed on every platform (e.g., base pad) and may serve as a starting point for the user to interact with the platform. It is responsible for initializing the platform after pluggable components are newly installed onto the platform. Part of the initialization process is the detection of newly installed components and communication with them. In addition, the chip can assign initial roles to each newly installed pluggable device, especially after first use. Either the user-installed microcontroller or the admin chip can handle subsequent role assignments for the existing pluggable components. The admin chip can also handle the initial communication of the platform (e.g., base pad) to the cloud (e.g., remote networked computing devices accessible via a communication network) and to other nearby platforms (e.g., other base pads within a given proximity depending on the communication protocol used for communicating with the other base pads). This communication may interact with a local or remote guidance system which can provide suggestions for the platform and installation instructions. In terms of security, the admin chip can help detect tampering and monitor for suspicious or malicious activity. This detection can be performed using authentication schemes to verify each newly installed pluggable component. In embodiments, the admin chip may monitor the health of the overall platform as well as the individual component within the platform. This mechanism lets the user know when to replace a pluggable component or the base pad. Therefore, the admin chip abstracts away many of the low-level installation and communication aspects from the user.

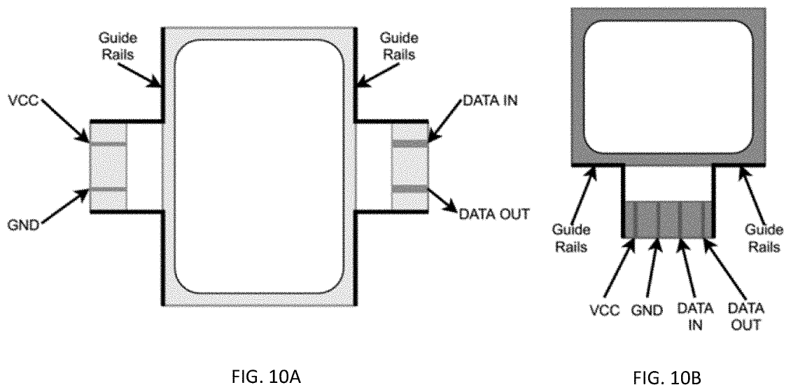

FIG. 10A depicts an example microcontroller slot within an example base pad, for use with embodiments of the present disclosure. FIG. 10B depicts an example pluggable slot within an example base pad, for use with embodiments of the present disclosure. The microcontroller manages the connected pluggable devices after the admin chip has initialized them. It runs with an operating system (OS) with a built-in artificial intelligence (AI) engine. This OS can automatically configure the platform over time with the help of admin chip depending on the connected pluggable device. The user can also program the platform's functionality through a smartphone app that connects to the target platform. The storage device allows for data collection and storage so that real-time operations can be performed, especially without the connection to external storage devices or cloud systems. Thus, the platform acts as an edge device. Depending on the application-specific computing requirements, the AI engine schedules the workload between the onboard microcontroller and available cloud computing units that are connected to the platform. In addition, the microcontroller is directly connected to the admin chip, which controls certain aspects of the platform which include, but not limited to, assigning physical access of the connected peripheral modules to the microcontroller. The admin chip also controls the AI engine and authorizes its communication to cloud services.

Instead of having two guide rails like in FIG. 10B for a pluggable device, the microcontroller slot in FIG. 10A has four guide rails to secure the many connections from the microcontroller into the contact points in the base pad. The microcontroller not only handles the data collection and processing on-board but also deals with the intra-communication among the pluggable devices and the inter-communication with other learning-rooted IoT platforms as described herein. The choice of the microcontroller can influence the number of usable device slot in the platform, meaning a weaker microcontroller can only handle a few number of pluggable devices.

To improve the lifetime of the microcontroller connecting block, the platform (e.g., base pad) may have a or slots for one or more storage devices connected directly to the microcontroller. With this configuration, a user program can be loaded onto a storage device which can be removed and replaced from its slot. This storage device not only can contain the program binary associated with the microcontroller, but it can also store data collected from the connected pluggable devices before sending them to another platform. The choice of this storage device depends on the complexity of firmware or operating system to be installed, as well as the amount of local storage required for the connected pluggable devices' data.

The microcontroller can be flashed with a static program that only specifies certain devices, functionalities, and positioning of the devices within the platform. This mode provides the most flexibility to the user, as they can customize the low-level software implementation of their design. However, this mode requires precise knowledge of all the devices on the platform regarding their type, purpose and position on the platform; alternatively, embodiments herein have self-awareness features which may eliminate some or all of the required knowledge on the part of the user.

A circuit diagram template for a pluggable device or a peripheral component is shown in FIG. 10B, and FIG. 7D shows the diagram of I/O connections and guide rails that would allow a peripheral I/O device to be installed onto the base pad. The bus that connects the pluggable devices to the microcontroller is shared among all the pluggable device slots. Due to this, any device that is designed to be a part of the platform should follow the template. This allows for a plug-and-play feature, where the OS automatically configures the functionality of the connected device.

As shown in FIG. 7C, each peripheral component has a handshaking circuit which talks to the admin chip and the user-selected microcontroller. After verification, the authorization for assessing the data bus is provided. The onboard PMU usually provides the power required for the peripheral device. In any scenario where a certain circuit on the peripheral device needs a different voltage level, a supporting circuit should be present to provide for the requirements. The supporting circuit can involve any circuitry that is required for running the peripheral device like voltage conversion circuits, amplifiers, etc. The Add-On circuit contains the main functioning element, be it a sensor or transducer or an actuator.

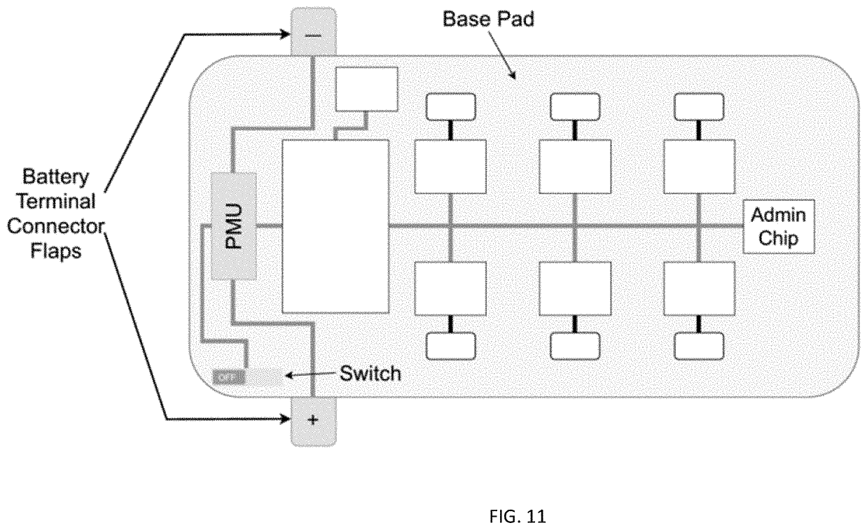

FIG. 11 depicts an example power management unit for use with an example base pad, according to embodiments of the present disclosure. In order to power the present platform (e.g., base pad) and all its components to the proper voltage levels, the power management unit (PMU) handles these tasks, monitors battery performance, and controls battery charging. The input to the PMU is the power coming from the solid-state battery via the battery terminal connector flaps. The PMU has a series of level shifters to accommodate different voltage levels of all the onboard components, such as microcontroller and pluggable devices. An external switch connects to the PMU, which controls the power supply to the entire platform shown in FIG. 11. The PMU has a set of preconfigured voltage levels that can be used to provide directly to the pluggable components. However, in a scenario where pluggable components have a different power requirement, the supporting circuit, as shown in FIG. 8 can be equipped to handle the preferred voltage conversion. The admin chip and the onboard microcontroller control the PMU for increased efficiency, depending on application specifications.

Near the power management and microcontroller slots in the FIG. 11 are the Battery Terminal Connector flaps, which connect to the battery that can be placed below the base pad in one embodiment of the UFLIP platform. In addition to this, there is a switch that controls the power supply to the entire platform. Both the terminal connector flaps and the switch connects to the power management unit slot in the circuit. When the flaps are attached to the battery, they act as the anchor for the left side of the pad. To secure the right side, there are Cuff Installation Holes as shown in FIG. 11 where they can be buttoned against the cuff on the back plate.

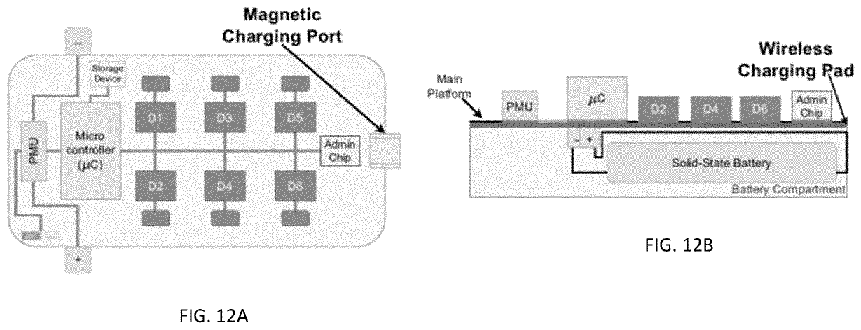

FIG. 12A depicts an example wired charging interface, for use with embodiments of the present disclosure. FIG. 12B depicts an example wireless charging interface, for use with embodiments of the present disclosure. The primary power supply of this platform comes from a thin solid-state battery. Due to the small form factor of this technology, newer solid-state battery technologies are leveraged that have very high-power density and are close to paper thin, still providing the charge necessary to operate the device ranging from a few hours to a couple of weeks. This depends on the installed devices and computational resources used. To charge the battery, the user can either remove the battery from the holder or charge it using an onboard magnetic charging port on the based pad as shown in FIG. 12A or use a wireless charging pad underneath the pad as shown in FIG. 12B. These interfaces allow for remote deployment of the present platform, which can be maintained using a network of Unmanned Aerial Vehicles (UAVs).

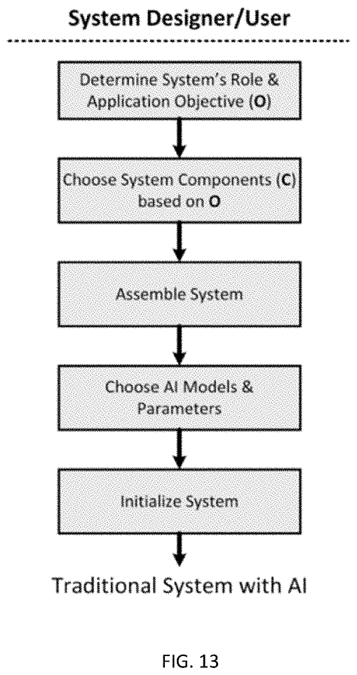

FIG. 13 depicts an example system design process. During the design process of traditional systems (including Traditional IoT systems), the AI models and the AI parameters are determined based on the system's hardware/software capabilities (see FIG. 13). In a system where the AI plays a vital role (e.g., an AI-centric system), it is rather unwise to select the AI models and parameters as an afterthought. Embodiments herein leverage a novel and alternative system design paradigm, where the AI models and parameters are selected based on the objectives and/or goals first and only after that the rest of system components are determined based on the AI specifications.

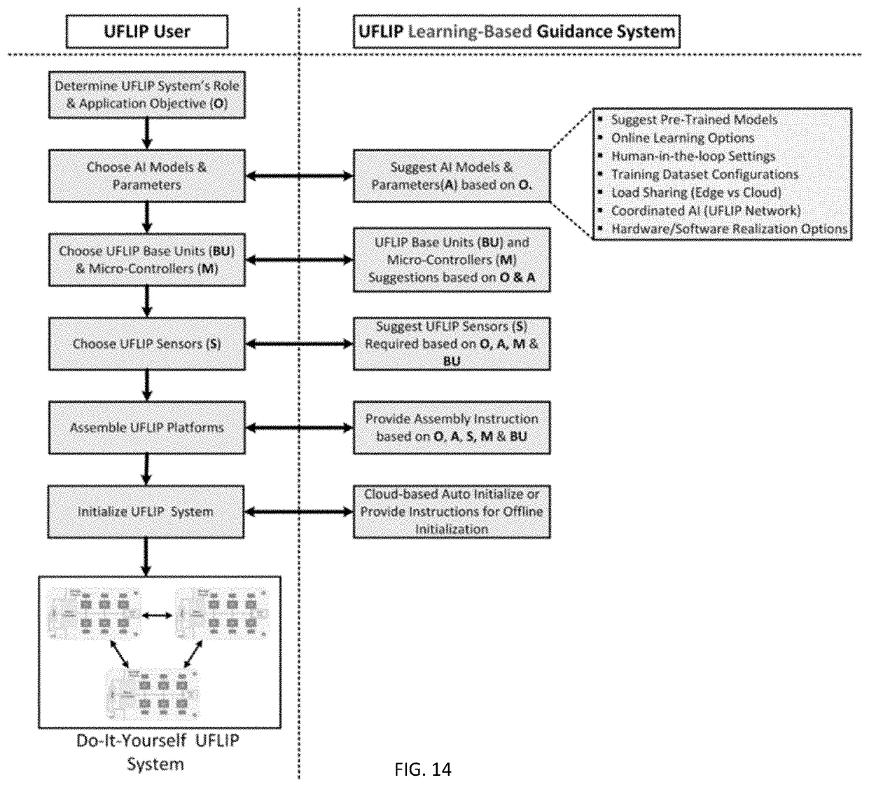

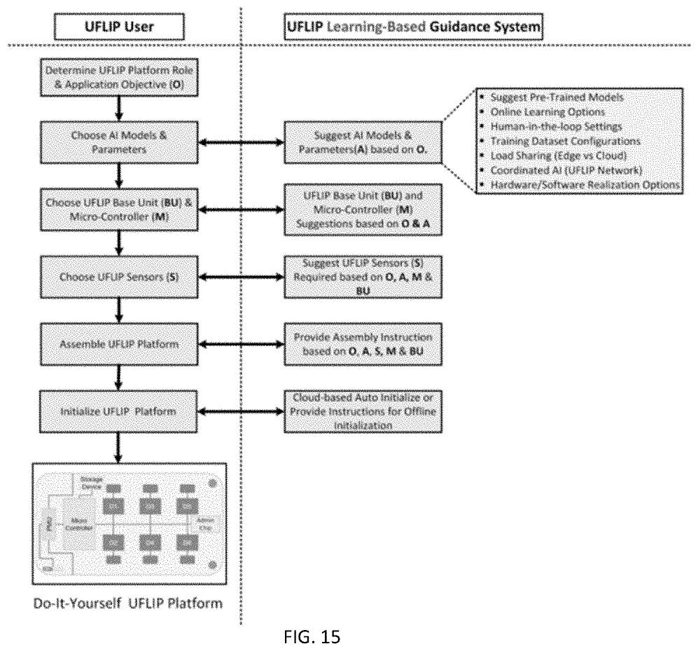

FIG. 14 depicts an example system design process for use with embodiments of the present disclosure. FIG. 15 depicts an example design procedure for a single learning-rooted IoT platform, in accordance with embodiments of the present disclosure. In FIG. 14, there are two entities: the user and the learning-based guidance system; learning-based guidance system can be implemented in the cloud and/or a mobile application. The role of user is to make the decisions regarding the application goals, AI model parameters, design, implementation, and start up procedures. The role of the learning-based guidance system is to provide suggestions and instructions to the user towards designing the learning-rooted IoT system. The guidance system learns from previous design experiences and continuously improves itself based user and empirical feedback.

Embodiments herein recognize the importance of AI specifications in an IoT system synthesis or design flow and propose an AI rooted IoT synthesis framework ideal for designing modern AI-centric IoT edge devices/systems. The system design optimization problem is framed herein using parameters and variables derived from both AI and traditional specifications/requirements. This joint AI-traditional optimization formulation is provided to a dynamic expert system, which generates a system design plan by referring to a machine-readable dynamic knowledge base. Based on simulation and deployment outcomes, the expert system capabilities are improved using reinforcement learning and inaccurate data in the knowledge base is corrected. Since the field of AI is rapidly evolving, the knowledge base is preferably periodically (e.g., or regularly) to reflect new innovations. Therefore, the present framework puts the AI specifications in the forefront of the IoT design process along with the traditional specifications, which can produce a better performing IoT edge device.

In embodiments, the design process may include, before selecting any of the components of the system, the user determining the role of their learning-rooted IoT system and objectives of their chosen application (O).

Based on the roles and objectives (O), the user chooses the AI models and parameters (A). In order for the user to have an informed decision, the guidance system can suggest AI models and parameters based on O. The guidance system can suggest the following AI models, parameters, and configurations, including but not limited to:
Suggest Pre-Trained Models: Depending on the objective (O), pre-trained AI models that are present in the guidance system repository are suggested. The user may choose to use a pre-trained model, use their own model or train a model from scratch. If the user is not sure about what to choose, the guidance system will make an optimal pick based on the application goals/objectives.
Online Learning Options: Depending on the chosen model, the user may enable online learning that will allow the AI model to evolve and adapt over time. If the user is not sure about this option, the guidance system can make an optimal pick based on the application goals/objectives.
Human-in-the-Loop Settings: The user may get more involved in the AI decision process by allowing human interaction with the AI model. In this setting, the AI model will ask for human intervention in risky and ambiguous scenarios. The AI model will also adjust itself based on the human supervision. If the user is not sure about this option, the guidance system will make an optimal pick based on the application goals/objectives.
Training Dataset Configurations: In an event, the AI model needs to be trained from scratch, datasets that are present in the guidance system repository are suggested. The user may choose to use some of these datasets or use their own datasets. If the user is not sure about what to choose, the guidance system will make an optimal pick based on the application goals/objectives.
Load Sharing (Edge vs Cloud): Sharing the AI computation load between the platform (e.g., base pad) and the cloud server is essential for obtaining good performance. The user can choose which specific AI related operations are to be done directly on the present platform and which operations are to be delegated to the cloud. If the user is not sure about this option, the guidance system will make an optimal pick based on the application goals/objectives.
Hardware/Software Realization Options: The user can specify which AI model operations are to be implemented in the hardware, which AI model operations are to be carried out using AI engines and which AI model operations are to be executed on the micro-controller as a software implementation. If the user is not sure about this option, the guidance system will make an optimal pick based on the application goals/objectives.
Coordinated AI (learning-rooted IoT network): If multiple connected platforms (e.g., learning-rooted IoT platforms; e.g., base pads) are to be used for a specific application, then the user may choose between a swarm or a hive-mind approach. In the swarm approach, each platform will make its own decision using its own AI model. In a hive-mind approach, all the platforms in the network will consult with each other and come up with a unified decision. If the user is not sure about this option, the guidance system will make an optimal pick based on the application goals/objectives.

The user next may choose the base units (denoted as BU) and the microcontrollers (denoted as M) with the suggestion from the guidance system which makes its recommendation based on O and M.

The user next may select the sensors (denoted as S) that goes onto their learning-rooted IoT system. The guidance system provides suggestions for which sensors should be required based on O, A, M, and BU.

With the A, BU, M, and S selected, the user assembles the platforms/system with the help of the guidance system providing the assembly instruction based on O, A, S, M, and BU. These steps constitute the selection and assembly steps for constructing a learning-rooted IoT system.

After system assembly, the user can finally initialize the learning-rooted IoT system. If the platforms are already connected to the cloud, the guidance system enables the cloud to auto initialize the system. Otherwise, the guidance system can provide some instructions to the user for initializing the system in offline mode.

### Self-Awareness Features

Manual administration of billions of small UFLIP devices is not feasible on this large scale. Hence, there is a need for the UFLIP platform to be as self-sufficient as possible. Self-awareness features are added to the UFLIP platform to make them self-sufficient. The self-sufficiency achieved via self-awareness can ensure proper communication with each pluggables and the platform, a smooth upgrade of each UFLIP components and their security.

The UFLIP platform has the communication capabilities among all the installed components as well as with other nearby platforms. The former describes intra-communication of pluggable components within a single platform, while the latter describes inter-communication among a neighborhood of UFLIP platforms. Self-aware intra-communication enables end user to add or replace different pluggable components in the platform without needing to reconfigure the software in the microprocessor and initializing them using the admin chip.

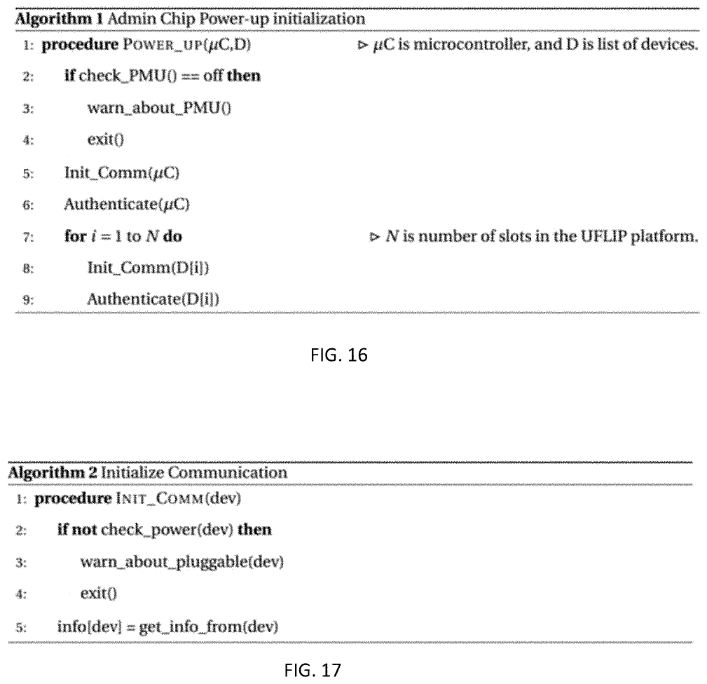

Example algorithm 1, in FIG. 16, demonstrates an example power-up initialization that the admin chip performs after first time installation or installation of new components. It first checks if the power management unit (PMU) is plugged in and working in the platform and warns the user whenever the PMU is not working properly. afterwards, the admin chip initializes the communication to the microcontroller and authenticates this connection. Subsequently, the admin chip then communicates with all the pluggable devices and authenticates each of those connections.

Example algorithm 2, in FIG. 17, demonstrates an example the initialization of communication for a given module, such as microcontroller and the pluggable devices. It first checks whether there is power to the given pluggable component. If there is no power detected as indicated by lack of response or low voltage reading, the admin chip warns the user about the power status of the pluggable component. Otherwise, it requests basic information from the pluggable components and stores it locally in the admin chip.

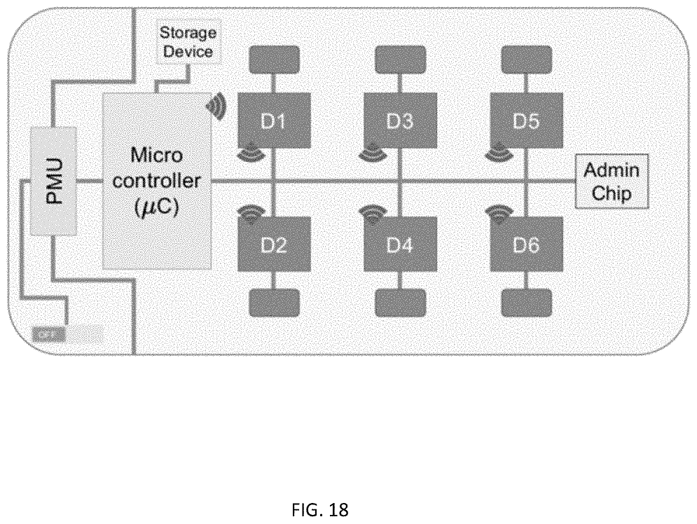

FIG. 18 depicts example wireless communication among components of an example learning-rooted IoT platform, according to embodiments of the present disclosure. A system according to various embodiments includes intra-communication interfaces, including physical interfaces as well as wireless connections. The copper traces provide the physical interfaces on the platform as the pluggable components are stuck on the pad via conductive contact points. Therefore, this interface provides the quickest response time because of the physical nature of this communication interface. Besides this, the pluggable components can also communicate wirelessly within the same platform. Wireless communication allows the pluggable devices to talk to all the other devices directly without burdening the I/O controller of the microprocessor. This way, the microprocessor can act more like a manager and coordinator, rather than the command center where all data exchanges happen.

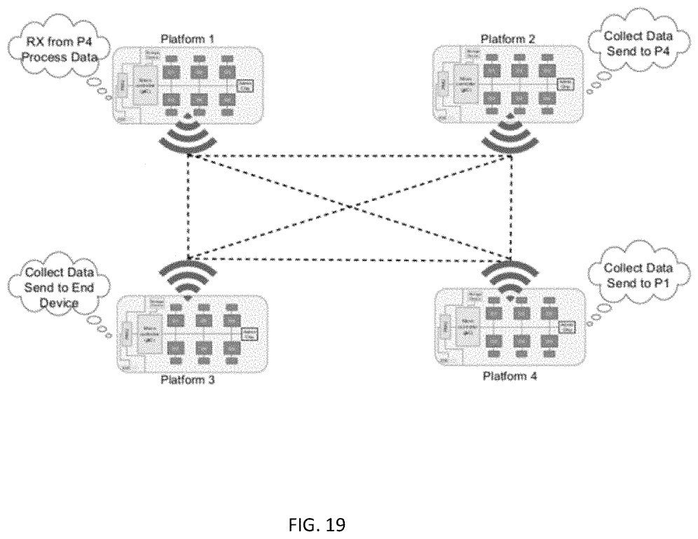

FIG. 19 depicts wirelessly networked learning-rooted IoT platforms, according to embodiments of the present disclosure. Self-aware inter-communication among the learning-rooted IoT platforms enables them to self-organize with one another in a local network. The primary interface for this inter-communication is via wireless interface. A group of learning-rooted IoT platforms can serve different tasks, such as collecting data, sending/receiving data, relaying commands from a coordinator or end device. If these tasks were either all or separately pre-programmed inside each learning-rooted IoT platform, the setup of these platforms can be a hassle to the end user. Instead, self-organizing communication is used among a network of nearby learning-rooted IoT platforms that distributes tasks effectively across them with the help of the admin chip in each platform. The advantage of this scheme is increased cooperation among the learning-rooted IoT platforms, reducing the overall workload of each individual learning-rooted IoT platform, thereby increasing their battery life. Therefore, this scheme can enable leaderless management of a group of learning-rooted IoT platforms, where no one learning-rooted IoT platform is assigned as leader with a possibility of being unavailable. When one learning-rooted IoT platform becomes down during runtime, the other learning-rooted IoT platforms can dynamically assign the task from the unavailable learning-rooted IoT platform onto others, reducing down-time without affecting the overall network.

An extension of the self-aware inter-communication is connecting the learning-rooted IoT platforms to the Internet. Just like locally connected network of learning-rooted IoT platforms, the main communication interface for this type of inter-communication is wireless. This self-aware inter-communication is for long-range or remote distance connections, mainly to outside of a local network of learning-rooted IoT platforms. With this scheme, the admin chip is primarily responsible for connecting the learning-rooted IoT platform to the Internet, especially upon first use. After connecting and configuring the chosen microcontroller, it then handles all subsequent connections to the Internet, which reduces the burden of the admin chip. This scheme allows a learning-rooted IoT platform or a local network of nearby interconnected learning-rooted IoT platforms to other learning-rooted IoT networks that are not necessarily nearby. With this, a learning-rooted IoT platform can exchange data with a faraway authenticated network of learning-rooted IoT platforms without having them be in a specific proximity. Moreover, this inter-communication via the Internet allows learning-rooted IoT platforms to communicate and transmit data to cloud platforms and applications, which can act as a data backup and hub for other networks of learning-rooted IoT platforms. Also, depending on the implemented AI model in the learning-rooted IoT platform, the cloud application can perform learning on the transmitted data quickly. Hence, the inter-communication among learning-rooted IoT platforms via the Internet enables the communication of a group of nearby learning-rooted IoT platforms with faraway learning-rooted IoT networks and the cloud.

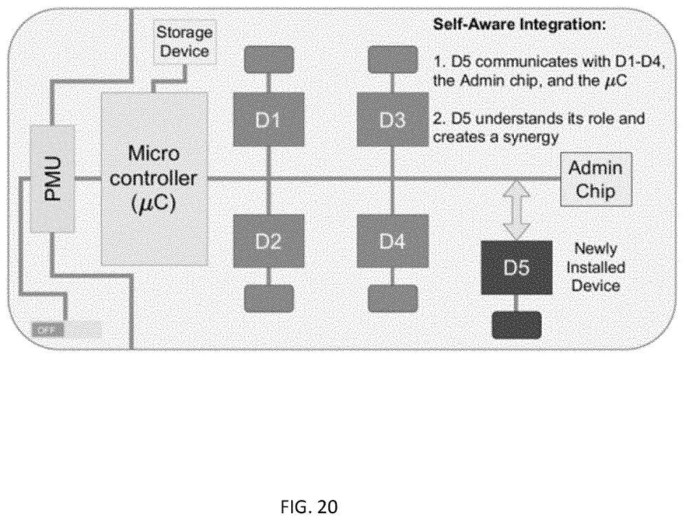

FIG. 20 depicts self-aware integration capabilities of example learning-rooted IoT platforms, according to embodiments of the present disclosure. In order to improve the usability of the onboard microcontroller, having a lightweight operating system (OS) in a storage device can allow for dynamic usage of the pluggable devices. This OS keeps track of the connected pluggable devices and their functionalities. The handshaking module on the pluggable device talks to the OS with the authorization from Admin chip, and depending on it, the program required to utilize the pluggable device is loaded manually or through a repository. The scope of the pluggable devices can be huge as they can be used to extend storage, add additional power sources, new sensors, wireless networking elements, transducers, etc. This ability can allow multiple of such learning-rooted IoT platforms to connect with each other either through a wired connection via the pluggable devices or through a wireless network. This mode also allows the end-user to create custom applications that can be uploaded to the storage device that abstracts away the low-level software implementation. Therefore, the microprocessor can have a mechanism to detect the device and their communication protocol on-the-go (e.g., plug and play).

With this configuration for the microprocessor, the learning-rooted IoT platform should be capable of automatically accommodating newly added devices in the platform. As shown in FIG. 20, the recently placed learning-rooted IoT devices can understand its role within the platform with respect to all the other devices and act accordingly. This can be achieved by having a set of programs/scripts ran in the microprocessor which are triggered when a new component/device is introduced, or an existing one is removed/replaced. These self-aware programs can be deterministic scripts or artificial intelligence models.

For example, assume a learning-rooted IoT platform connected to a car is used to record pollutant levels at different locations. Assume that the learning-rooted IoT platform already has an ozone detector, a particulate matter detector, and a carbon monoxide detector. Now, if the user plugs in a new sulfur dioxide detector on the learning-rooted IoT platform, then the admin chip will automatically configure this new sensor, employ it to detect sulfur dioxide levels, and report/store the values along with the other sensors' values.

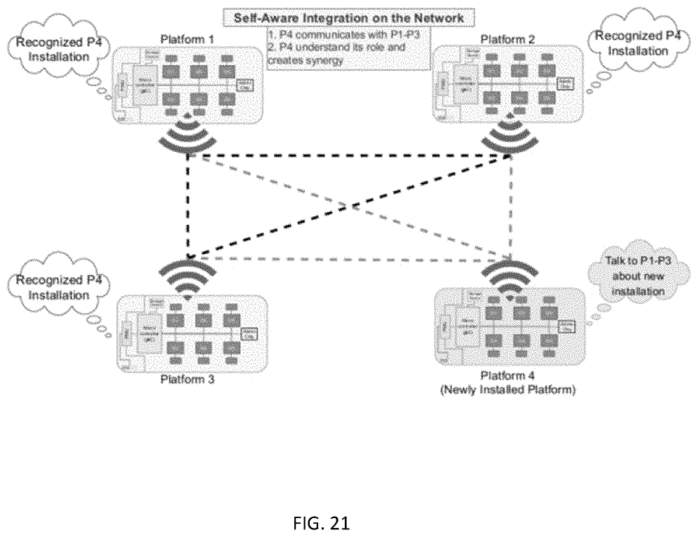

FIG. 21 depicts example integration among learning-rooted IoT platforms, according to embodiments of the present disclosure. The concept of self-aware integration can be extended to the level of a learning-rooted IoT network. The network of learning-rooted IoT platforms consists of unit learning-rooted IoT platforms performing a set of similar or dissimilar tasks. When a new learning-rooted IoT platform is connected to this network, the connected learning-rooted IoT platform will coordinate with other learning-rooted IoT platforms in the network to identify its role within the network (See FIG. 21). The intelligence behind this job assignment and coordination can be based on swarm intelligence or based on guidance from a leader learning-rooted IoT platform.

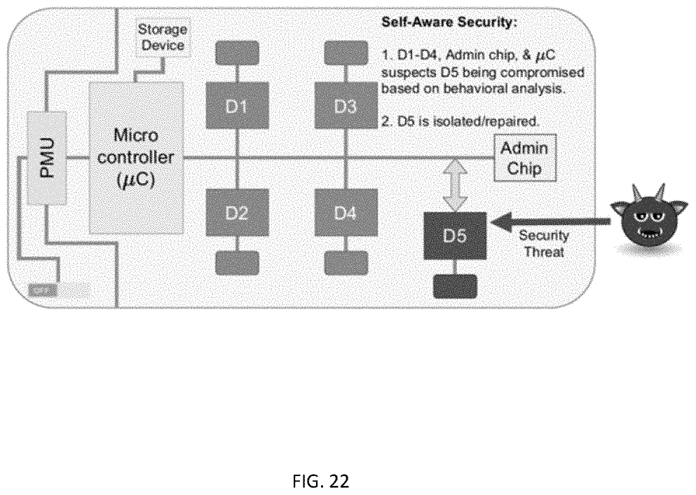

FIG. 22 depicts example security among learning-rooted IoT platforms, according to embodiments of the present disclosure. Self-awareness can also ensure the security of individual components as well as the entire system. As seen in FIG. 22, when a particular component is attacked by an adversary, the system will detect and adjust itself based on the situation. The detection is possible by behavioral analysis of each component by every other component. When a potential attack is detected, the attacked component is isolated, and repair is attempted. This ensures that the entire system operates as intended with minimal human interaction. For example, say an attacker tampers a particular sensor component in a palatable to report erroneous/malicious values. The other components can detect this abnormal behavior and isolate/reset the affected port or pluggable device.

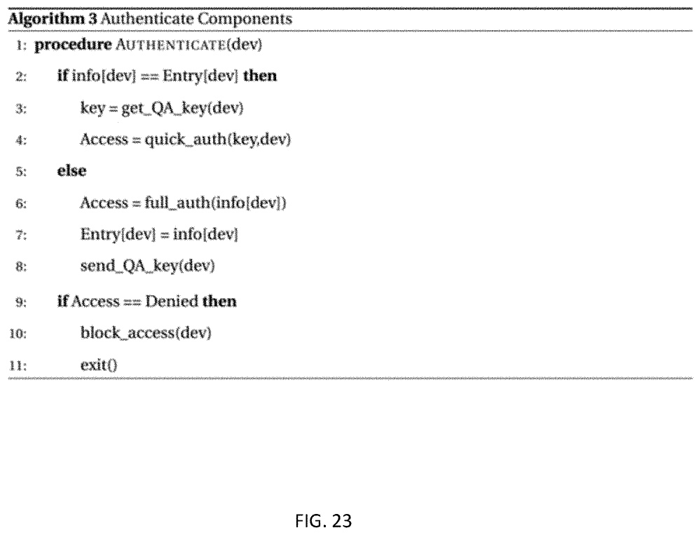

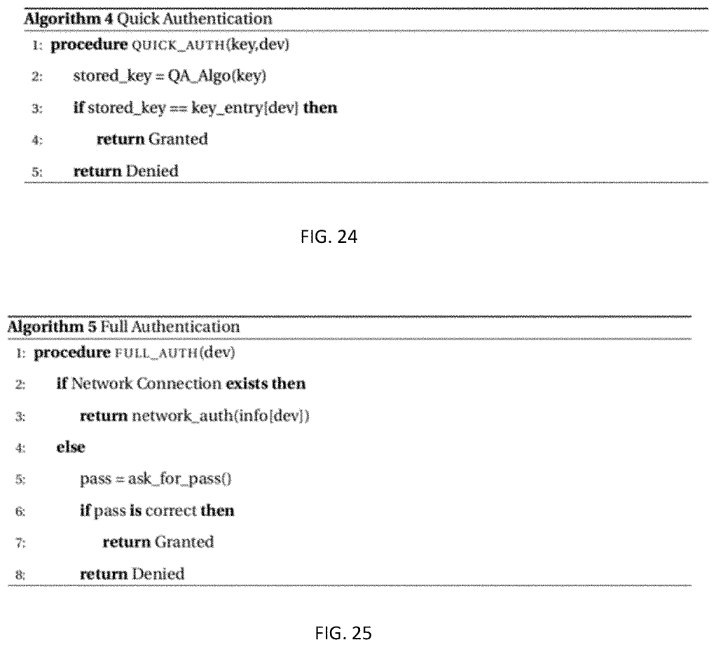

FIGS. 23 (e.g., example algorithm 3), 24 (e.g., example algorithm 4), and 25 (e.g., example algorithm 5) depict example authentication operations for use in accordance with various embodiments of the present disclosure.

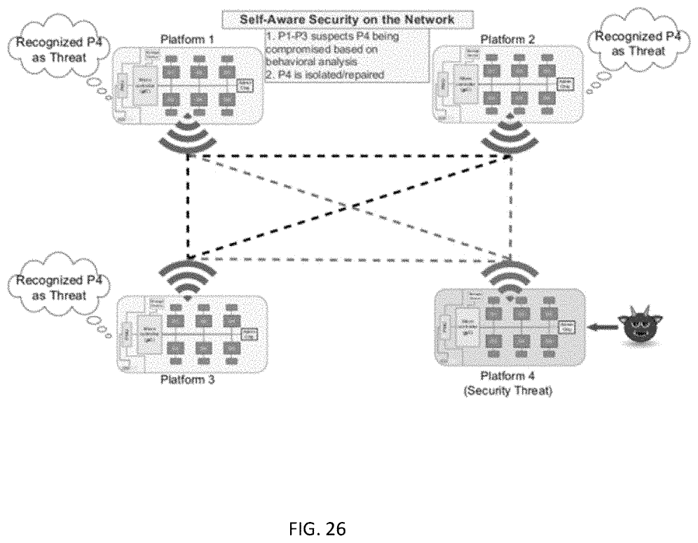

FIG. 26 depicts example security among learning-rooted IoT platforms, according to embodiments of the present disclosure. The concept of self-aware security can be extended to the level of a learning-rooted IoT network. The network of learning-rooted IoT platforms consists of learning-rooted IoT platforms performing a set of similar or dissimilar tasks. When a learning-rooted IoT platform is attacked or compromised, the other learning-rooted IoT platforms will (1) detect this event based on the behavior of the compromised learning-rooted IoT platform and (2) will act to repair/isolate the compromised learning-rooted IoT platform (e.g., see FIG. 26).

### Use Cases

Example use cases for the proposed learning-rooted IoT platform are based on the reconfigurability of the learning-rooted IoT platform through pluggable and portable peripheral components. This can be used to deploy and implement portable IoT devices rapidly in a small form factor.

Wildlife Monitoring: learning-rooted IoT platforms located in the wild will be able to track rare animal movements, detect poachers, and perform surveillance. The self-aware nature of the learning-rooted IoT platform will ensure easy integration and automatic safety.

Forest Fire Detection: learning-rooted IoT platforms deployed in the forests can be used to detect forest fire and alert relevant entities.

Appliance Monitoring and Diagnosis: Use of learning-rooted IoT platforms to monitor the device health of appliances and automobiles to their exterior to aid earlier detection and diagnosis of potential maintenance issue before they become a major hassle.

Reconfigurable Smart Body Patch (Pasteables) for Pose Estimation: Use of a reconfigurable stick-and-peel learning-rooted IoT platform called Pasteables designed to detect and track hu-man pose can be used to (1) ensure workout safely, (2) guide physiotherapy, and (3) help with creating human-prosthetic synergy.

DIY IoT Gateway: learning-rooted IoT platform provides a rich IoT based feature set to traditional devices that are not capable of connecting to a network, helping the user to automate, enhance productivity of the devices and extend the life of such devices which would not be possible otherwise.

Weather & Traffic Monitoring Using learning-rooted IoT platform Deployed on Cars: Using learning-rooted IoT platform with a barometer, temperature/humidity sensor, and infrared sensor on cars will allow easy collection of traffic and weather data which can help in many other applications. Self-awareness of learning-rooted IoT platform will certainly enhance usability and effectiveness.

Pollution Monitoring from air, terrestrial, or water vehicles: Monitoring pollution at ground, in air or at water is a useful application. Using learning-rooted IoT platform(s) with air quality monitor and gas/pollutant concentration sensors, once can easily monitor air population over land bodies, over water bodies and in air. Water/soil quality can also be monitored using UFLIP platforms. The moving vehicles will also help in terms of high area/volume coverage.

Monitoring patients in both hospital and home settings: Patients can also be easily monitored using learning-rooted IoT platform with vital sign monitors (e.g., heart rate monitors and thermometer) on-the-body or in different parts of the patient room. IR sensors for detecting movement and pressure sensors for detecting walking motion can easily detect patient activity.

Pedestrian monitoring using pressure sensor learning-rooted IoT platform on the sidewalk for safety: learning-rooted IoT platform with pressure sensors on the sidewalk can easily detect the pedestrian density to allocate the proper time corresponding to this density.

Traffic density monitoring using pressure sensor learning-rooted IoT platform on the road: learning-rooted IoT platform with pressure sensors on the road can be used to track car traffic density for better traffic monitoring and management.

Forest Fire Detection & Wildlife Surveillance

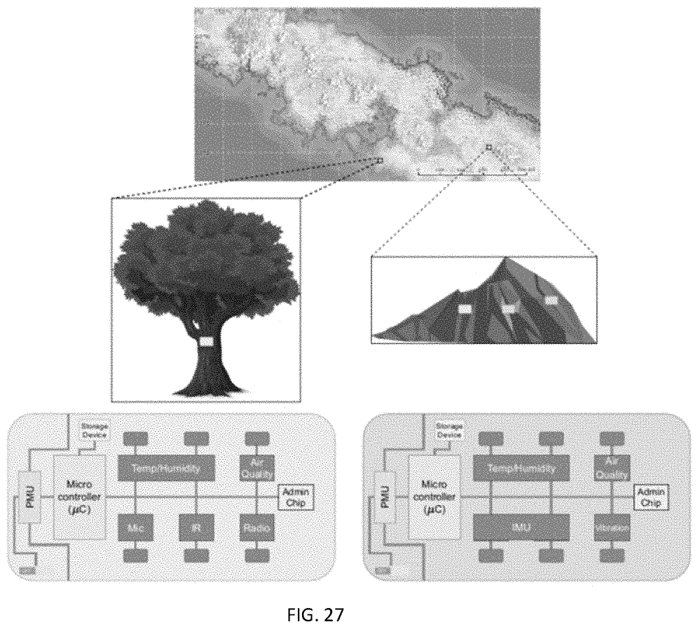

FIG. 27 depicts an example use case for deploying IoT devices in a remotely inconvenient location, including but not limited to forests and mountains, according to embodiments of the present disclosure. Many of the learning-rooted IoT platforms in this use case can be used to monitor the surroundings and wildlife where they are deployed. In the forest deployment, the learning-rooted IoT platform includes a temperature/humidity sensor, air quality sensor, microphone, IR transceiver, and radio communication module. With these devices, one can monitor the environmental temperature, humidity, air quality, forest fire and relative noise in the surroundings. This learning-rooted IoT platform can also monitor movement around this particular tree and can communicate to the base station via radio. This same learning-rooted IoT platform can be used to monitor parts on the mountain as shown in FIG. 27. An additional type of learning-rooted IoT platform is deployed in the mountain where it contains a temperature/humidity sensor, air quality sensor, IMU, and a vibration sensor. The inclusion of the IMU and vibration sensor can help detect movement in the mountain as a result of landslide or earthquakes.

Often, the terrain where these learning-rooted IoT platforms are to be installed is relatively unknown to the user. Instead of buying an entire platform with parts that can be considered unusable later on, the learning-rooted IoT platform allows the user to customize each target device depending on what they are trying to monitor and the surroundings. As these learning-rooted IoT platforms can be deployed in a re-mote location, their maintenance can become a hassle, especially if the entire platform needs to be replaced for any type of upgrade. However, the reconfigurability of the learning-rooted IoT platform requires only the replacement of the problematic component, rather than the entire platform. Remote maintenance systems, such as those with UAVs, can easily perform these removal and replacement tasks. As this platform has an accessible charging port or is equipped with a wire-less charging interface, a remote maintenance system can charge up the system easily without requiring a human to trek to the remote location to perform these tasks.

Appliance Monitoring and Diagnosis

Another application of the learning-rooted IoT platform is for appliance monitoring and diagnosis to detect issues, especially on appliances without a computer that monitors their device health. A learning-rooted IoT platform can be deployed to appliances and automobiles with handpicked sensors to monitor certain activities in them. This use case is similar to the remote deployment of learning-rooted IoT platforms but without the limited connectivity to the Internet. The data collected from these learning-rooted IoT platforms provide diagnostic information to help users and maintenance people to localize certain issues based on the placement of these platforms.

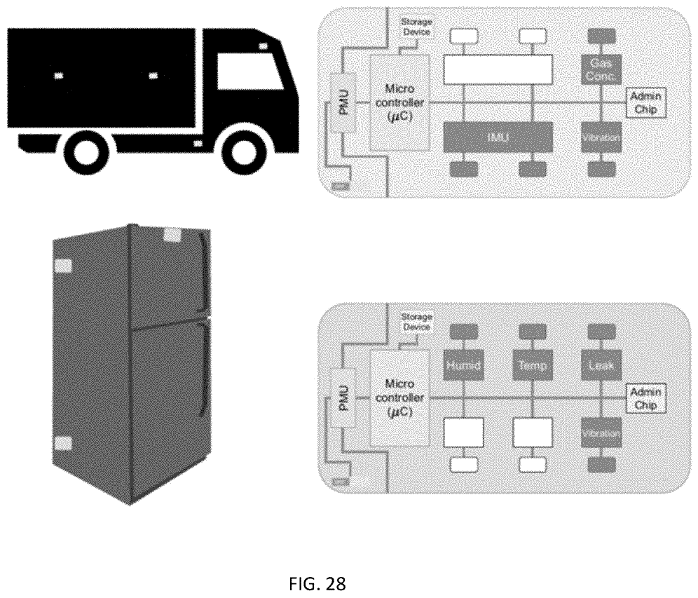

FIG. 28 depicts an example of the monitoring and diagnosis use case in automobiles and appliances, in accordance with embodiments of the present disclosure. For an automotive such as a truck, a user can select an IMU, gas concentration sensor, and vibration sensors to augment the diagnostic capability of the internal computer system, as these platforms would be placed externally. These sensors can be used to detect leakage and excessive vibration not picked up by the internal computer. On the other hand, for appliances such as refrigerator, a user can include a humidity, temperature, leakage, and vibration sensors to detect spillage of liquids, such as coolants, to operate the fridge. They can also be used to monitor excessive vibration due to damages beyond normal wear and tear. As these appliances are likely to be located in areas with Internet connection, these diagnostic learning-rooted IoT platforms can transmit their monitoring data in a more frequent periodicity. This way, they can catch maintenance issues that often go undetected over time before they become a hassle.

Reconfigurable Smart Body Patches (e.g., Pasteables)

Wearable devices, such as smartwatches and fitness bands, are being increasingly used for fitness and sport performance monitoring. Conventional wearable and health monitoring devices track a small set of health and/or motion parameters and are permanently configured to be used within one use case, such as, detecting incorrect exercise motion, identifying flaws in a dancing student's pose, catching synchronization issues with synchronized swimming or gymnastics, tracking walking posture problems, and monitoring an athlete's performance issues. Due to this, multiple wearable devices are needed for each application, which can be costly to the end user wanting to perform all these tasks. The tight coupling between the platform, the hardware components and the software application limits possibilities and leads to under-utilization of different system components. Therefore, a cost-effective and reconfigurable wearable platform which can be re-purposed for many applications will be highly appreciated in the fitness and sports industry.

Embodiments herein enable a new paradigm of stick-and-peel, reconfigurable, cost-effective, secure, and user-configurable wearable devices (referred to herein without limitation as pasteables), which can be employed in diverse fitness/health/sports applications. A set of pasteables according to embodiments herein can create an on-body network of sensors for one or more users to collectively perform diverse tasks. Each pasteable may consist of a base pad and pasted-on components, such as a microcontroller (referred to herein as a brain in pasteable (BIP)), power management unit, peripheral devices (e.g., sensors and actuators), and a notification LED array. The BIP communicates with an end computing device (e.g., smartphone or cloud device) for data transmission and decision making. Peripheral devices are implemented uniformly in a wrapper circuit with a peripheral controller, which can be programmed to communicate using the same interface. With these components, embodiments herein (e.g., pasteables) can configure their own system automatically, so the wearer only focuses on pasting the sensors, determining what data they want to collect, and how to process them for achieving the target functionality. Prototypes built according to embodiments herein have been built using a plastic sheet for structural support, copper sheet strips for the interconnections, and skin-safe adhesive to stick the pad to the skin or clothing (e.g., like a band-aid).

Pose and posture detection applications are widely used in fitness and athletics monitoring. Camera-based techniques for pose/posture detection compromise user privacy with data like faces and locations. They also need an external fixed reference for calibration. Available camera-less systems for pose/posture detection are expensive and not reconfigurable.

To address these issues with existing solutions, embodiments provide for a set of pasteables for performing a multitude of applications, including but not limited to: (1) detecting correct/incorrect fitness exercise motions, (2) detecting a specific exercise based on the subject's motion, and (3) determining walking posture correctness. These applications can be extended to sports training, fitness workout, dance, physiotherapy, and other fitness applications. With the framework, cost-effective utilization of the same set of base pads and CUIs is possible to realize a diverse set of applications.

Embodiments herein provide for a stick-and-peel (e.g., adhesive) (e.g., band-aid-like) wearable platform (e.g., referred to herein as pasteables), that can be easily adapted to a wide range of applications in the fitness and athletic domain. Embodiments allow on-the-fly hardware component swapping and software reconfiguration using a simple interface.

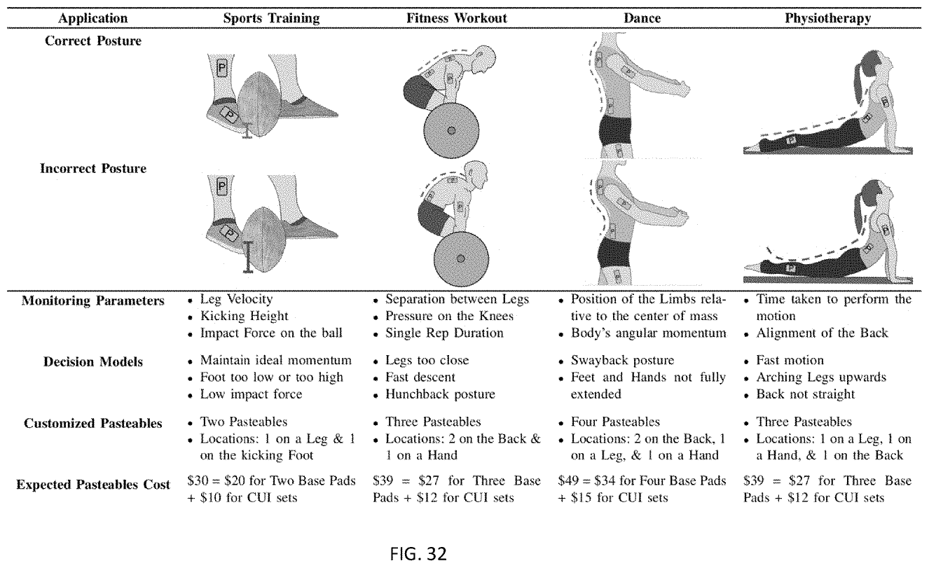

Most common wearables are smart patches and smart bands. Smart bandages can treat wounds and other skin injuries as a smart patch by detecting the required antibiotic to prevent the spread of bacterial infections. However, these are often single use and offer little in fitness applications. Smart bands are primarily used in sports training, fitness workout, dance, and physiotherapy as shown in FIG. 32. Examples of conventional devices include the FitBit® series and Apple® Watch series, which cost $80 and $399 for their base models in 2021, respectively. There are inexpensive options, but they only have some features of their high-end counterparts. Moreover, these wearables lack customizability in reconfiguring the hardware and software. Switching out sensors and components either is near impossible or requires buying an entirely new system. These limitations restrict the wearer's control and can be costly over time. Thus, an affordable wearable where the wearer can customize its hardware and software should be developed to help solve these issues.

Table 1 summarizes pose and posture monitoring approaches in terms of flexibility in detecting different poses/postures, ease of use, need for a stationary reference, security, affordability, and classification accuracy. Camera-based works have explored solutions using visual sensors, which require an external stationary reference where the device location needs to remain constant. Mobile devices can implement them accurately and affordably for detecting many exercises. However, cameras pose privacy issues as it could film private data like their faces and locations. A camera-less system can help resolve this issue while detecting exercise pose and walking posture and correctness in performing them.

The earliest camera-less system for spinal posture analysis was implemented using an electromagnetic inclinometer. Other camera-less systems used sensors like strain gauge, electromagnetic (EM), and flex sensors. To create affordable systems, these works used few sensors which can only detect a few actions. Moreover, an external reference is not needed, as the system's calibration provides the reference. Without cameras, they do not film the user, greatly improving their privacy. Many camera-less approaches use Inertial Measurement Units (IMU). One such smart patch for back posture detection is Upright Go. Other approaches use motion capturing systems, such as Xsens Dot, LpMoCap, and Noraxon, which require specialized spaces and are prohibitively expensive for the public. However, they are significantly accurate for pose and posture detection in these specific environments, but not anywhere else. Thus, an inexpensive, accurate, and easy-to-use camera-less system for detecting various poses can help mitigate issues with existing approaches.

TABLE 1

| | Camera- | IMU- | Other Camera- | Present |
|---|---|---|---|---|
| | Based | Based | less Systems | Embodiments |
| Functional | High | Medium | Low | High |
| Flexibility | | | | |
| Ease of Use | Medium- | Low- | Low | High |
| | High | Medium | | |
| External | Required | Not | Not | Not |
| Stationary | | Required | Required | Required |
| Reference | | | | |
| Security/ | Low | High | High | High |
| Privacy | | | | |
| Affordability | Low | Low- | Medium- | High |
| | | Medium | High | |
| Accuracy | High | Medium- | Medium- | High |
| | | High | High | |

The existing technologies lack reconfigurability. Additionally, designing custom monitoring devices for niche applications is also challenging due to lack of industry incentive. These limitations must be addressed in newer wearables in order to meet the evolving needs of the fitness and athletics industries. Hence, there is a need for a customizable and easy-to-use wearable platform that can perform various fitness and athletics monitoring, such as pose and posture detection. Such a device can potentially lead to reduced cost due to reuse and quick/easy development cycles.

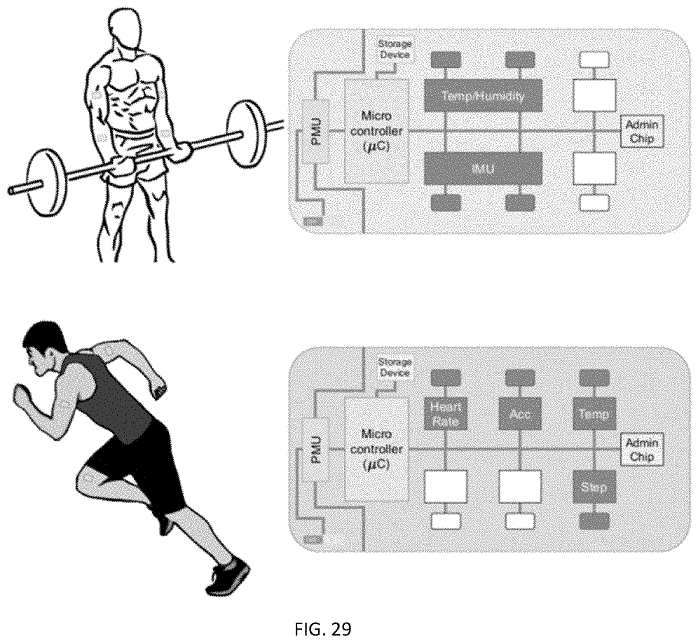

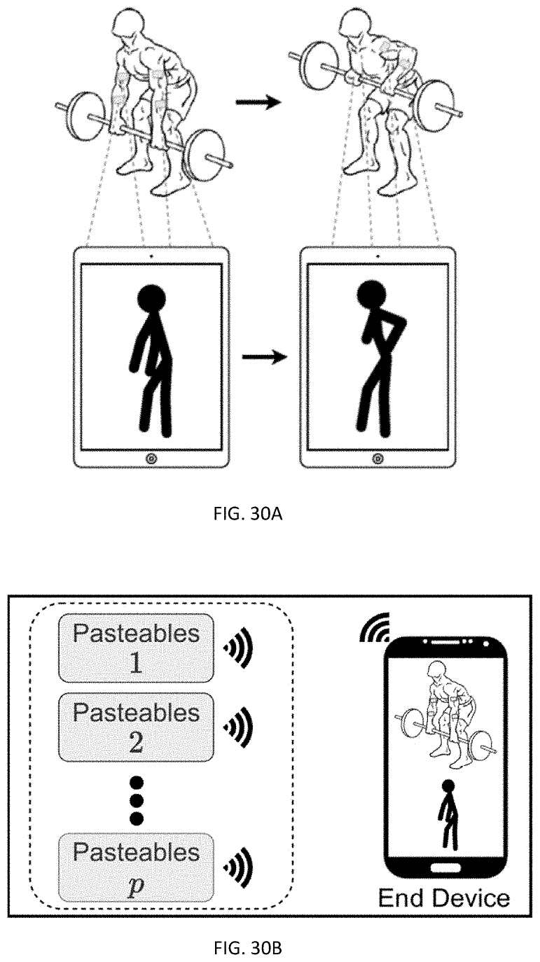

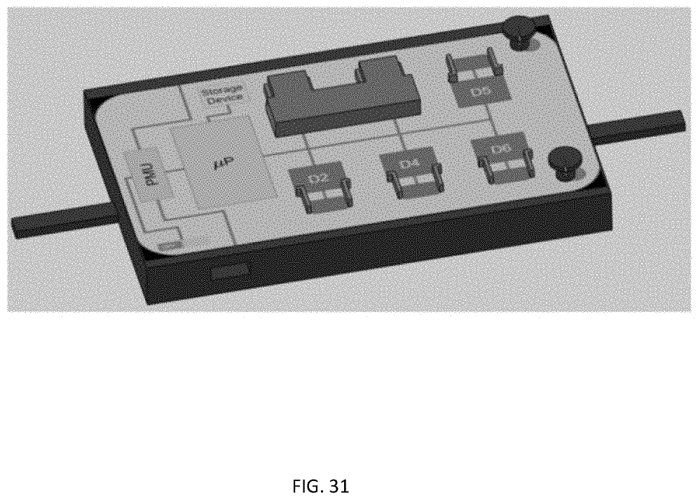

FIG. 29 depicts an example smart fitness device configured in accordance with embodiments of the present disclosure. FIGS. 30A and 30B depict monitoring using an example smart fitness device configured in accordance with embodiments of the present disclosure. FIG. 31 depicts a 3-dimensional (3D) view of a device configured in accordance with embodiments of the present disclosure.

A set of learning-rooted IoT devices (e.g., in the form of reconfigurable smart body patches or pasteables as referred to herein without limitation) placed on the human body can be used to detect pose and monitor health signals. An example is a smart fitness device as shown in FIG. 29 for two kinds of exercise: weightlifting and running. In the weightlifter example, there are four smart patches across both of their arms, which contain a combined temperature and humidity sensor and an inertial measurement unit (IMU). With these sensors, the weightlifter can monitor the temperature and humidity as well as estimate the pose based on the acceleration and rotation of their arms as shown in FIGS. 30A and 30B. Both of these learning-rooted IoT devices occupy two device slots each as they require more data lines than one device slot can provide. FIG. 31 shows a 3D view of a device configured in accordance with embodiments here, where the device occupies two slots in the platform (e.g., base pad). With this design, the 2-slot device does not block the access to the other slots. Besides the two devices, the device slots are empty as indicated by the white boxes next to each device, which can be used for other sensors or actuators if the weightlifter decides to monitor more signals at a later time.

The runner in FIG. 29 has smart patches (not shown; e.g., base pads configured in accordance with embodiments herein) on their arms and some on their knees. In these patches, there are the heart rate monitor, accelerometer, temperature sensor, and step counter. The heart rate monitor provides the pulse rate information throughout the run to monitor variations and spikes. The accelerometer and pedometer give speed information and number of steps respectively for tracking these statistics over different runs. The temperature sensor measures possible overheating and thereby dehydration incidents, especially if the runner runs at a high-temperature location. Similar to the weightlifter's patch, there are two empty device slots below the heart rate monitor and accelerometer devices for additional devices down the line should the user wish to add them.

A group of pasteables according to embodiments herein can monitor health parameters and limb movements by wirelessly connecting themselves to an end device (e.g., computer and cloud) as shown in FIGS. 30A and 30B. They can also be configured to create a wireless body area sensor network, with each serving as a reconfigurable edge IoT device. Hence, the wearer can easily set up the hardware on the pasteables with the software automatically configuring them.

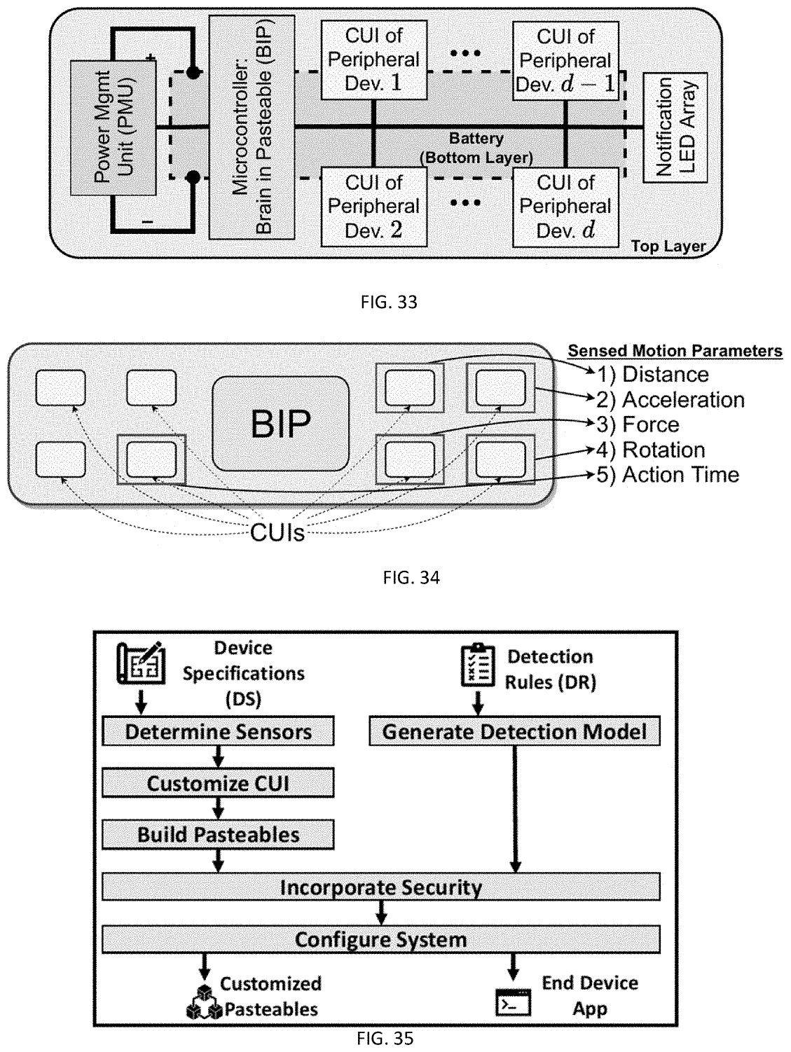

FIG. 33 depicts an example hardware platform of a reconfigurable smart body patch (e.g., pasteable) in accordance with embodiments of the present disclosure. In FIG. 33, the example hardware platform includes a bottom layer for a battery and a top layer for hardware components (e.g., a power management unit (PMU), microcontroller, CUIs of peripheral devices, notification LED array). Components may be pasted-on to the base pad and then the base pad may be pasted onto the skin or clothing. The battery connects to the PMU, powering the entire platform. The stick-and-peel nature of these pasteables makes an excellent case for their ease of use, rather than creating a device from scratch.

FIG. 34 depicts example components with uniform interfaces (CUI) of an example hardware platform of a reconfigurable smart body patch accordance with embodiments of the present disclosure. Peripheral devices (e.g., sensors, actuators, transducers) are contained in a wrapper circuit to create a component with uniform interface (CUI), which uses the same material as the base pad. The CUIs are designed to be as bendable as the base pad. A power converter takes the input voltage and shifts it to the correct voltage for the peripheral device if necessary. Moreover, the peripheral controller manages and collects data from the actual peripheral device as well as communicates them to the BIP.

FIG. 35 depicts an example designing framework of a reconfigurable smart body patch accordance with embodiments of the present disclosure. The designing framework helps to create a customized pasteables system for tracking different fitness and health parameters. It requires both device specifications (DS) and a set of detection rules for the task (DR). Also, a set of measurable entities is defined as X. For one embodiment, X={Distance, Acceleration, Force, Rotation, Action Time} as shown in FIG. 2d. DS={P1, P2, . . . , PN}, where each Pi∈DS is the ith Pasteable's specification. Pi={X₁ⁱ, X₂ⁱ . . . , X_{Ci}ⁱ}, where each Xⱼⁱ∈Pi is sampled from X. DR is a set of rules crafted based on values from all the peripheral devices. For example, one rule can be [angle(X₁ⁱ,X₁²)>Th1]. The angle between P1 and P2 (computed based on distances X₁¹, X₁²) being greater than Th1 can be one rule for an application. Based on DS, the necessary sensors and their CUIs are generated along with the necessary pasteables hardware components are crafted. Using DR, the detection model is generated for the given task, along with the necessary security protocols. The final output is the complete system, S={Customized Pasteables, End Device App}.

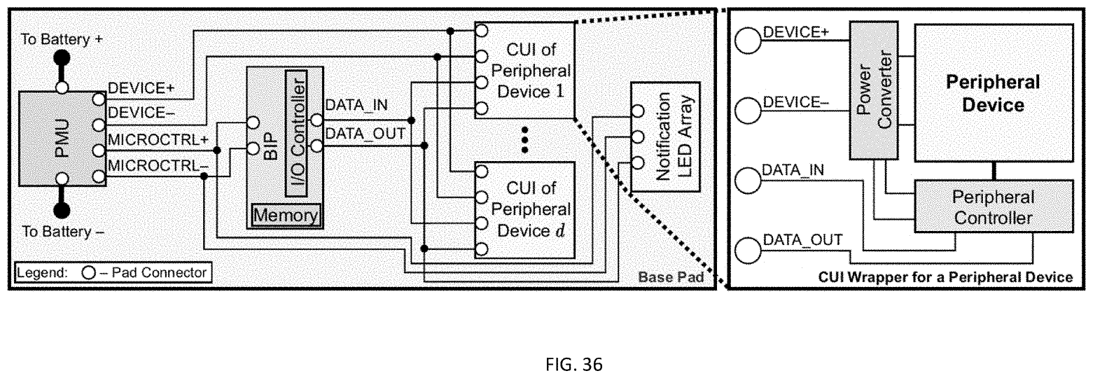

FIG. 36 depicts an example base pad and peripheral device circuit of an example reconfigurable smart body patch accordance with embodiments of the present disclosure. FIG. 36 shows the base pad and peripheral device circuit diagrams. Within the base pad, the PMU converts the battery's voltage to correct values for the BIP and peripheral devices. BIP initializes, communicates with, and collects data from the pasted-on peripheral devices using its internal I/O controller. It also handles communication with the end device and other pasteables. An LED array is connected to the BIP, notifying the wearer of their activity status. Like the LED array, the peripheral devices also connect to the microcontroller. With this design, the wearer can customize the hardware within a pasteables platform by unplugging and replacing components.

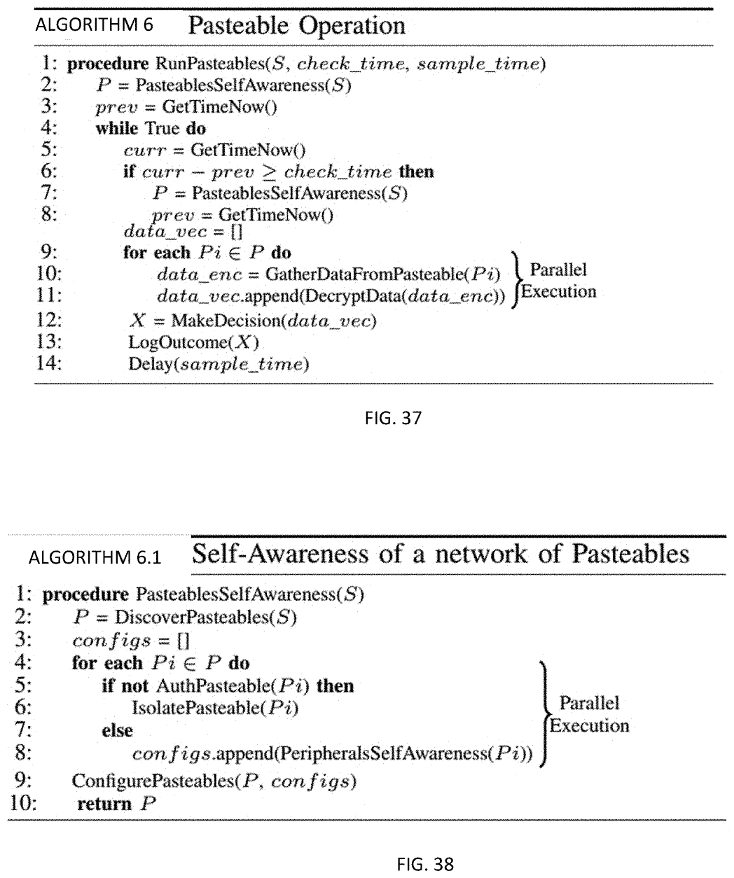

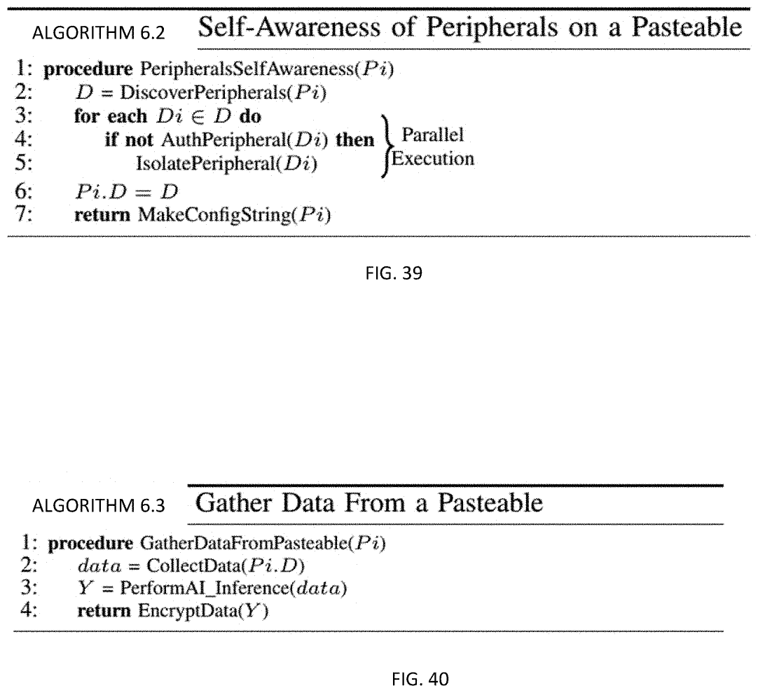

FIGS. 37, 38, 39, and 40 depict example operations for use in accordance with embodiments of the present disclosure. FIG. 37 may be referred to as algorithm 6, depicting example operation of a pasteable in accordance with some embodiments of the present disclosure. FIG. 38 may be referred to as algorithm 6.1, depicting example operation for self-awareness of a network of pasteables in accordance with some embodiments of the present disclosure. FIG. 39 may be referred to as algorithm 6.2, depicting example operation for self-awareness of peripherals on a pasteable in accordance with some embodiments of the present disclosure. FIG. 40 may be referred to as algorithm 6.4, depicting example operations in accordance with gathering data from a pasteable in accordance with some embodiments of the present disclosure.

The uniform and systematic approach to constructing pasteables helps to create algorithms to self-configure and operate a group of pasteables and peripherals. RunPasteables( ) (see, e.g., FIG. 37) interacts with the network of pasteables and calls the other procedures to set up and operate the pasteables. It calls PasteablesSelfAwareness( ) (see, e.g., FIG. 38) to auto-configure the system of pasteables provided from synthesis framework. To set up the peripheral devices, example algorithm 6.2 (see, e.g., FIG. 39) may be called. After establishing all the pasteables and peripheral devices, the main procedure collects data using GatherDataFromPasteable( ) (see, e.g., FIG. 40) periodically.

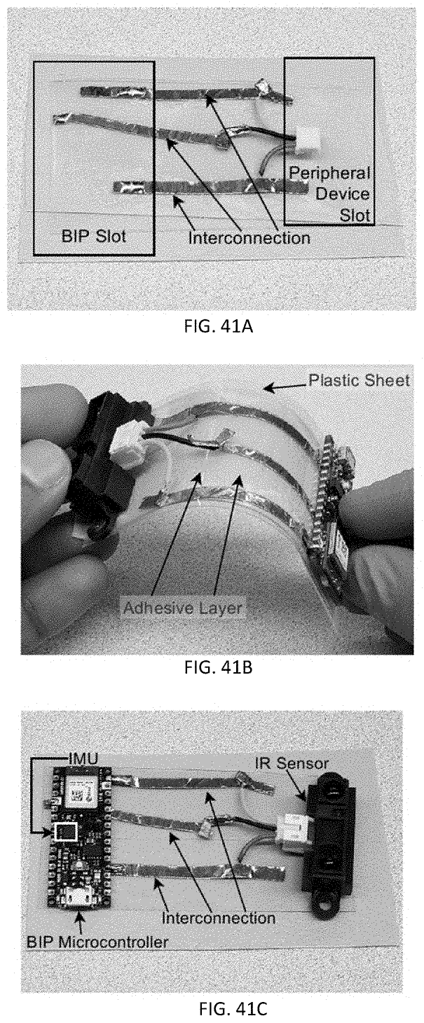

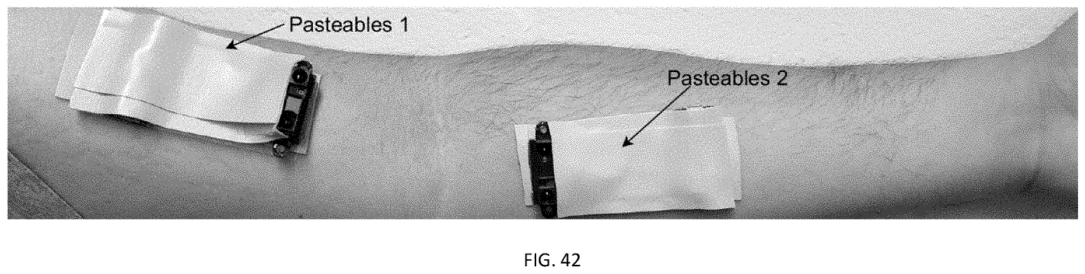

FIGS. 41A, 41B, and 41C depict example reconfigurable smart body patches accordance with embodiments of the present disclosure. FIG. 42 depicts an example reconfigurable smart body patch accordance with embodiments of the present disclosure.

FIG. 41A illustrates a base pad built on top of a skin-safe adhesive (e.g., Nexcare Waterproof adhesive). It is very flexible, and its tensile characteristics are similar to textile. The BIP and sensor are adhered to (e.g., glued onto) the base pad, connected via a removable interconnect using thin copper sheet strips. This interconnect bus is soldered to the BIP and sensor for power and data transmission. It can also contract and expand in unison with the base pad due to added length. A JST PH 2.0 male-to-female connector connects the sensor to the BIP. To improve the tensile strength of the base pad, a thin, flexible plastic sheet was added over the adhesive layer, improving the rigidity slightly as shown in FIG. 41B. Adding the plastic sheet improves the integrity of the base pad and the adhesive surface; it also maintains flexibility without needing to apply stickier substance to adhere to the skin or clothing.

FIG. 41C shows the pasted-on components for the example device. The BIP is an Arduino Nano 33 microcontroller due to its small form factor. It also has a Wi-Fi module to communicate with the end device and other pasteables as well as a simple PMU. The BIP is connected to a 110 mAh lithium-ion battery and provides 3.3V to the peripheral devices. An IMU and infrared (IR) sensor were chosen for the peripheral devices, e.g., Arduino's IMU and the Sharp GP2Y0A21YK IR sensor. The IMU provides acceleration and rotation data via the accelerometer and gyroscope, and the IR sensor provides the distance measurement. Since they are off-the-shelf components, they have on-board power converters, so an external power converter is not needed. Using these off-the-shelf components helped simplify the prototype design while maintaining a form factor suitable for on-the-body applications. Alternative embodiments may utilize flexible electronics and PCBs to replace all the rigid elements, such as the BIP controller and the IR sensors.

BIP has self-awareness capabilities to auto-configure and operate a pasteables platform. Discovering peripheral devices is done by tracking pre-allocated pins for each device within the BIP. Each pasteable communicates using their Wi-Fi modules and the UDP protocol for rapid data transmission. The end device (e.g., a computing device) may configure how to handle the peripherals' data stream based on the pasteables' configuration strings. The decrypted data packet can be used for training or inferencing, depending on the application requirements. For example, pasteables can use this data to infer correct pose and posture as well as notify the wearer of the action. Therefore, the software prototype of this pasteables design seamlessly configures and operates the pasteables without having the wearer interact with the low-level implementation.

Experiments involving example reconfigurable smart body patches (e.g., pasteables) according to embodiments herein were performed with two different setups for performing three tasks: (1) exercise pose correctness detection, (2) exercise pose classification, and (3) walking posture correctness detection. The details of these setups are listed below.
Setup 1 has one pasteable with the IMU as the only sensor.
Setup 2 has two pasteables with the IMU and IR sensors.

Five volunteers performed correct and incorrect exercise poses (e.g., bicep curls, side lunges, and squats) and walking postures while wearing pasteables on (adhered to) their body. For example, FIG. 42 shows pasteables (e.g., Pasteables 1 and Pasteables 2) on the arm of a human. Beforehand, volunteers watched videos from a fitness trainer on the correct and incorrect poses for each exercise. After performing each motion ten times, the participants performed baseline actions, such as sitting and standing ten times each. To collect walking posture data, pasteables were removed and placed on the neck and, later, on the back. Then, the participants walked normally and with a hunched back for 10 times each. The data helps investigate whether using one or two sensors as well as one or two pasteables is more accurate.

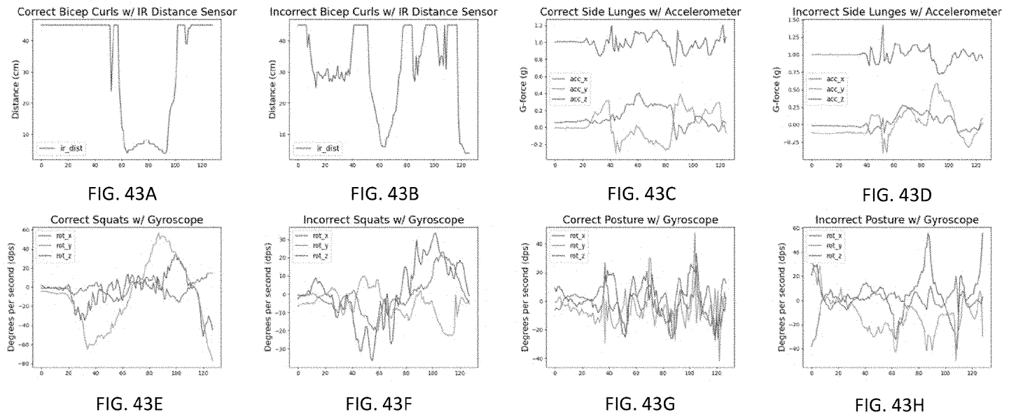

FIGS. 43A, 43B, 43C, 43D, 43E, 43F, 43G, and 43H depict sensor data collected using example reconfigurable smart body patches accordance with embodiments of the present disclosure. FIGS. 43A-H show raw data samples from sensors which highlight the difference between correct and incorrect poses. All of the data points are used to train a random forest (RF) classifier with 500 trees, as it uses many decision trees, making it less prone to outliers. Further, it is validated for 30 folds to collect and verify the classification accuracy, recall, and precision. Thus, this experimental setup provides the capability to test different pasteables configurations and how they affect the accuracy of the pose and posture classification and correctness detection.

The first experiment investigates the accuracy of detecting whether an exercise pose is correct using pasteables. Both correct and incorrect pose raw data, excluding the IR sensor data, were preprocessed using Linear Discriminant Analysis (LDA) technique to reduce the number of features. LDA makes the RF classifier less prone to overfitting, improving the accuracy to above 80%. Table 2 summarizes the first experiment's results. Setup 2 has a mean higher accuracy across the exercises than Setup 1. However, the very high accuracy of the Squats pose in Setup 1 could be due to LDA eliminating the noise in the data. The lower accuracy in Setup 2 may be due to more noise introduced when adding more sensors. The IR distance sensor in Setup 2 tracks the distance between the two limbs, which helps to differentiate the correct poses. Consequently, adding more sensors track more physiological parameters, and pasteables increase accuracy for detecting correct and incorrect exercise poses. Since this platform is affordable to make, attaching more pasteables and sensors is feasible and can improve the accuracy of the exercise pose classification and correctness detection.

TABLE 2

| | Bicep Curls | | Side Lunges | | Squats | |
|---|---|---|---|---|---|---|
| | Setup 1 | Setup 2 | Setup 1 | Setup 2 | Setup 1 | Setup 2 |
| Recall (%) | 83.56 | 91.33 | 91.11 | 89.78 | 100.00 | 97.56 |
| Precision (%) | 83.73 | 93.59 | 86.57 | 92.11 | 100.00 | 97.73 |
| Accuracy (%) | 83.3 | 92.33 | 88.22 | 90.89 | 100.0 | 97.56 |

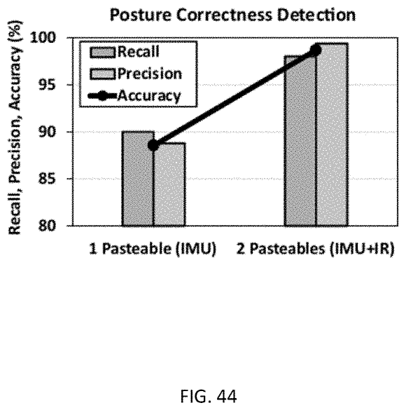

FIG. 44 depicts posture correctness detection using an example reconfigurable smart body patches accordance with embodiments of the present disclosure. The second experiment evaluates the accuracy of detecting correct proper walking posture as summarized in FIG. 44. Like in the first experiment, the posture data were preprocessed using LDA to improve accuracy to above 90%. Setup 2 has a 9% accuracy improvement over Setup 1 compared to the first experiment. Consequently, Setup 2 significantly improves the posture correctness detection like in the first experiment, as the IR sensor tracks the arch of one's spine. With these two experiments, the pasteables platform also allows for effective pose and posture detection without having a stationary reference, because the pasteables move with the wearer. Therefore, using multiple pasteables platforms can perform both detection tasks accurately without this reference.

The third experiment assesses the nature of the action performed across different exercises as summarized in Table 3. This task is more challenging than the first experiment due to high variance (across individuals and different actions). It looks at the three exercises (Bicep Curls, Side Lunges, and Squats) along with standing and sitting. Only the correct pose data was analyzed for this experiment. Unlike the first experiment, the pose data were not preprocessed with LDA as accuracies are above 90%. Setup 2 is 5% more accurate than Setup 1, a larger difference compared to the first experiment. This higher accuracy helps differentiate the actions across different exercises using more sensors for monitoring other relevant data. For similar implementations with added recon-figurability, an accurate reconfigurable wearable is feasible for action pose differentiation.

TABLE 3

| | Setup 1: One Pasteable | | | | | Setup 2: Two Pasteables | | | | |
|---|---|---|---|---|---|---|---|---|---|---|
| | (with IMU) | | | | | (with IMU and IR) | | | | |
| | Bicep | Side | | | | Bicep | Side | | | |
| | Curls | Lunges | Squats | Standing | Sitting | Curls | Lunges | Squats | Standing | Sitting |
| Recall (%) | 95.11 | 90.44 | 88.44 | 95.78 | 89.33 | 99.33 | 89.78 | 97.33 | 100.00 | 98.2 |
| Precision (%) | 85.01 | 97.70 | 95.06 | 91.31 | 94.39 | 100.00 | 98.40 | 92.87 | 98.61 | 96.23 |

| | | |
|---|---|---|
| Accuracy (%) | 91.82 | 96.93 |

Through these three experiments, Setup 2 produced a higher accuracy than Setup 1 for detecting correct pose and postures. As the pasteables infer the five parameters for posture detection, they estimate accurately the correctness of a particular pose or posture. Hence, this can be extended to applications like sports training, fitness workout, dance, and physiotherapy with great accuracy using multiple pasteables. With the current setup, the cost of each prototype is approximately $30 based on the prototype's bill of materials. Removing unneeded BIP components and accounting for mass manufacturing with scaling, the cost of the base pad would conservatively cost $15 per board and $1-3 per CUI or even less. Compared to the existing consumer wearables, these pasteables are more affordable and customizable for their intended application.

Other types of smart patch body sensor platforms may be utilized with embodiments herein. A smart nutrition tracker can be loaded with a strain sensor and a camera to track jaw movement and take pictures of the food being consumed. This information can be sent to the user's phone and can be shared with a medical and nutrition professional. Another smart patch application is for emergency and remote patient monitoring. In areas with a lack of emergency response equipment, a low-cost custom smart patch can be configured to monitor vitals of accident victims in remote areas.

DIY IoT Gateway

Many of the devices present in the current market are not yet capable out of the box to connect to a network. They also lack capabilities that would make a device smart, though the number of devices capable of doing so are increasing. But for all the devices manufactured until now without IoT functionality, this platform can be a gateway. The reconfigurability of the platform would allow a user to adapt the platform to a particular device or a set of devices. The platform could provide the ability to connect to a network, control and monitor a “non-smart” device essentially giving the device IoT capabilities. It can connect to a variety of devices including but not limited to washing machines, refrigerators, air-conditioners, lights, fans, etc. The capacity to connect to any device in a home can potentially allow a user to automate almost all the devices and convert his living space into a smart-home.

The application of providing a gateway to the internet can also be extended to industrial machines, where automating old machinery using such gateway devices could save a lot of cost in machinery upgrade, production time, remote control/access and quality control. The ability of the platform to share resources with a cloud computing unit can potentially help the device to scale down its performance and size, making the platform easily adaptable to any requirement on the work floor. The inbuilt Admin chip provides state-of-the-art security capabilities to ensure privacy concerns and securing the devices to which the platform is being connected to. The deployed platform can not only connect itself to the central cloud unit but also can communicate between surrounding such platforms. This enables a localized information flow to perform tasks quickly in a real time work environment.

### VI. Machine Learning

References to artificial intelligence (AI) and learning herein may refer to machine learning or deep learning tasks.

The term “machine learning model” refers to a machine learning task. Machine learning is a method used to devise complex models and algorithms that lend themselves to prediction. A machine learning model is a computer-implemented algorithm that can learn from data without relying on rules-based programming. These models enable reliable, repeatable decisions and results and uncovering of hidden insights through machine-based learning from historical relationships and trends in the data.

A machine learning model is initially fit or trained on a training dataset (e.g., a set of examples used to fit the parameters of the model). The model can be trained on the training dataset using supervised or unsupervised learning. The model is run with the training dataset and produces a result, which is then compared with a target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g., the number of hidden units in a neural network). In some embodiments, the machine learning model is a regression model.

The term “target variable” refers to a value that a machine learning model is designed to predict. Historical data is used to train a machine learning model to predict the target variable. Historical observations of the target variable are used for such training.

The terms “dataset” and “data set” refer to a collection of data. A data set can correspond to the contents of a single database table, or a single statistical data matrix, where every column of the table represents a particular variable (e.g., a predictor variable), and each row corresponds to a given member (e.g., a data record) of the data set in question. The data set can be comprised of tuples (e.g., feature vectors). In embodiments, a data set lists values for each of the variables (e.g., features), such as height and weight of an object, for each member (e.g., data record) of the data set. Each value is known as a datum. The data set may comprise data for one or more members, corresponding to the number of rows.

The term “data record” refers to an electronic data value within a data structure. A data record may, in some embodiments, be an aggregate data structure (e.g., a tuple or struct). In embodiments, a data record is a value that contains other values. In embodiments, the elements of a data record are referred to as fields or members. In embodiments, data may come in records of the form: (x, Y)=(x₁, x₂, x₃, . . . , xₖ, Y) where the dependent variable Y is the target variable that the model is attempting to understand/classify, or generalize. The vector x (e.g., feature vector) is composed of the features x₁, x₂, x₃, etc. that are used for the task. The features may be representative of attributes associated with a data record.

The term “feature vector” refers to an n-dimensional vector of features that represent an object. N is a number. Many algorithms in machine learning require a numerical representation of objects, and therefore the features of the feature vector may be numerical representations. Embodiments herein may transform features of a feature vector into numerical representations.

In the pattern recognition field, a pattern is defined by the feature xi which represents the pattern and its related value yi. For a classification problem, yi represents a class or more than one class to which the pattern belongs. For a regression problem, yi is a real value. For a classification problem, the task of a classifier is to learn from the given training dataset in which patterns with their classes are provided. The output of the classifier is a model or hypothesis h that provides the relationship between the attributes xi and the class yi. The hypothesis h is used to predict the class of a pattern depending upon the attributes of the pattern.

The term “regression model” refers to a supervised model in which the dependent variable is a numeric variable. Regression analysis is a machine learning algorithm that can be used to measure how closely related independent variable(s) relate with a dependent variable. An extensive use of regression analysis is building models on datasets that accurately predict the values of the dependent variable. At the beginning of regression analysis, a dataset can be split into two groups: a training dataset and a testing dataset. The training dataset can be used to create a model to figure out the best approach to apply the line of best fit into the graph. Thus, it can be a straight line or a curve that easily fits into the graph of the independent variable(s) vs the dependent variable. The newly created model can be used to predict the dependent variable of the testing dataset. Then, predicted values can be compared to the original dependent variable values by using different accuracy measures like R-squared, root mean square error, root mean average error, correlation coefficient and others. If the accuracy score is not accurate enough and a stronger model wants to be built, the percentage of the datasets allocated to the training and testing datasets can be changed. For instance, if the training dataset had 70% of the dataset with the testing dataset having 30%, the training dataset can now have 80% of the dataset with the testing dataset having 20%.

Another way of obtaining a stronger model is by changing from linear regression analysis to polynomial regression analysis or from multiple linear regression analysis to multiple polynomial regression analysis. There are different regression analysis approaches for continuous variables such as Linear Regression, Multiple Linear Regression, Polynomial Regression and Multiple Polynomial Regression.

The term “classification model” refers to a supervised model in which the dependent variable is a categorical variable. A classification model may be referred to as a classifier.

The terms “classifier algorithm” or “classification algorithm” refer to a classifier algorithm which estimates a classification model from a set of training data. The “classifier algorithm” uses one or more classifiers and an associated algorithm to determine a probability or likelihood that a set of data (e.g., a plurality of input data records) belong to another set of data (e.g., a distribution represented by a data set, or a distribution represented by a true data set). Put another way, a classification problem involves distinguishing one or more classes of data from other classes of data. An example of such a classification problem may involve a model trained to distinguish a first data set from a second data set. A decision tree model where a target variable can take a discrete set of values is called a classification tree (e.g., and therefore can be considered a classifier or classification algorithm). Neural networks, naive Bayes, decision trees, and support vector machines are examples of classifiers.

In decision analysis, a decision tree can be used to visually and explicitly represent decisions and decision making. In data mining, a decision tree describes data (but the resulting classification tree is used as an input for decision making).

In embodiments, a decision tree is in the form of a tree structure, where each node is either a leaf node (indicates the prediction of the model), or a split node (specifies some test to be carried out on a single attribute-value), with two branches. A decision tree can be used to make a prediction by starting at the root of the tree and moving through it until a leaf node is reached, which provides the prediction for the example.

In decision tree learning, the goal is to create a model that predicts the value of a dependent variable based on several independent variables. Each leaf of the decision tree represents a value of the dependent variable given the values of the independent variables, represented by the path from the root to the leaf (passing through split nodes).

The term “numeric variable” refers to a variable whose values are real numbers. Numeric variables may also be referred to as real-valued variables or continuous variables.

The term “ordinal variable” refers to a variable whose values can be ordered, but the distance between values is not meaningful (e.g., first, second third, etc.).

The term “categorical variable” refers to a variable whose values are discrete and unordered. These values are commonly known as “classes.”

The term “dependent variable” refers to a variable whose value depends on the values of independent variables. The dependent variable represents the output or outcome whose variation is being studied. A dependent variable may also be referred to as a response, an output variable, or a target variable.

The terms “independent variable” or “predictor variable” refer to a variable which is used to predict the dependent variable, and whose value is not influenced by other values in the supervised model. Models and experiments employed herein may test or determine the effects that independent variables have on dependent variables. Supervised models and statistical experiments test or estimate the effects that independent variables have on the dependent variable. Independent variables may be included for other reasons, such as for their potential confounding effect, without a wish to test their effect directly. In embodiments, predictor variables are input variables (e.g., variables used as input for a model are referred to as predictors). In embodiments, predictor or input variables are also referred to as features. Independent variables may also be referred to as features, predictors, regressors, and input variables.

The terms “supervised model,” “model,” and “predictive model” refer to a supervised model, which is an estimate of a relationship in which the value of a dependent variable is calculated from the values of one or more independent variables. The functional form of the relationship is determined by the specific type (e.g., decision tree, GLM, gradient boosted trees) of supervised model. Individual numeric components of the mathematical relationship are estimated based on a set of training data. The set of functional forms and numerical estimates a specific type of supervised model can represent is called its “hypothesis space.”

Artificial intelligence, learning, or machine learning provides significant technological improvement over systems that do not employ such features. For example, through the use of machine or other learning, large volumes of data can be reviewed to discover trends and patterns that would not be apparent to humans; indeed, the large volumes of data may be reviewed in a much shorter amount of time than would be possible by human review, while the data remains relevant or fresh. That is, if a human were to manually review the data, the lapse of time between when the data was relevant or fresh and when the trend or pattern is discovered, or the task is complete may be so large that the data/trend/pattern/decision is obsolete. Moreover, as a machine learning algorithm gains experience, it keeps improving in accuracy and efficiency, leading to better decision making. As the amount of data keeps growing, the algorithms are continuously trained, and they learn to make more accurate predictions faster. Machine learning algorithms are good at handling data that are multi-dimensional and multi-variety, and they can do this in dynamic or uncertain environments.

Machine learning algorithms further identify variables that are most important for determining a given prediction, decision, or other output. In doing so, less important variables can be identified as variables that can be ignored in the analysis; this significantly reduces computing resources required for a given analysis.

### VII. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A plug-and-play base pad apparatus, the apparatus comprising:
one or more ports, each configured for hosting a pluggable component;
one or more of an administration chip or a microcontroller configured to control the apparatus and the one or more ports;
a battery configured to power the apparatus; and
a power management unit configured to monitor the battery and interface with charging mechanisms.

2. The apparatus of claim 1, wherein a first port of the one or more ports is communicably coupled with the microcontroller.

3. The apparatus of claim 2, wherein a second port of the one or more ports is communicably coupled with a storage device.

4. The apparatus of claim 1, wherein one or more of the administration chip or the microcontroller is further configured to communicate with a remote client device.

5. The apparatus of claim 4, wherein one or more of the administration chip or the microcontroller is further configured to control the apparatus and the one or more ports based at least in part on instructions received from the remote client device.

6. The apparatus of claim 5, wherein the instructions received from the remote client device originate via a mobile application interface displayed by the remote client device.

7. The apparatus of claim 1, wherein one or more of the administration chip or the microcontroller is further configured to detect a pluggable component upon a coupling of the pluggable component with a port of the one or more ports.

8. The apparatus of claim 1, wherein one or more of the administration chip or the microcontroller is further configured to detect a security threat posed by a pluggable component coupled with a port of the one or more ports.

9. The apparatus of claim 8, wherein one or more of the administration chip or the microcontroller is further configured to isolate the port based on having detected a security threat posed by the pluggable component coupled thereto.

10. The apparatus of claim 1, wherein the pluggable component comprises a peripheral I/O component.

11. The apparatus of claim 1, wherein the pluggable component comprises an IoT device.

12. The apparatus of claim 1, wherein the charging mechanism is one or more of wireless or wired.

13. The apparatus of claim 1, wherein one or more of the administration chip or the microcontroller is further configured to detect one or more other base pad apparatuses located within a proximity of the apparatus.

14. A system, comprising:
a plurality of plug-and-play base pad apparatuses according to claim 1.

15. The system of claim 14, wherein each plug-and-play base pad apparatus of the plurality of base pad apparatuses is configured with one or more machine learning models.

16. The system of claim 15, wherein computational tasks are distributed among the plurality of plug-and-play base pad apparatuses based at least in part on the one or more machine learning models.

17. A system for monitoring environmental status of a remote location, the system comprising:
a plurality of plug-and-play base pad apparatuses according to claim 1.

18. A system for monitoring appliances, the system comprising:
a plurality of plug-and-play base pad apparatuses according to claim 1.

19. A system for monitoring physiological parameters associated with a live subject, the system comprising:
a plurality of plug-and-play base pad apparatuses according to claim 1.

20. The system of claim 19, wherein the plug-and-play base pad apparatuses comprise adhesive patches for attaching them to the live subject.

21. A system for monitoring traffic parameters or safety, the system comprising:
a plurality of plug-and-play base pad apparatuses according to claim 1.

22. A guidance system for generating a learning-rooted IoT system, the guidance system comprising at least one processor and at least one non-transitory storage medium storing instructions that, when executed by the at least one processor, configure the guidance system to:
receive one or more of a system role or system objectives associated with an application for the learning-rooted IoT system;
determine, based at least in part on the system role or system objectives, one or more AI models and one or more parameters;
determine, based at least in part on the system objectives and one or more selected microcontrollers, one or more base units for the learning-rooted IoT system;
determine, based at least in part on one or more of the system objectives, the one or more base units, the one or more AI models, the one or more selected microcontrollers, or the one or more base units, one or more sensors for the learning-rooted IoT system; and
initialize, according to initialization instructions, the learning-rooted IoT system.

23. The guidance system of claim 22, further configured to suggest one or more of the one or more AI models, one or more parameters, one or more base units, one or more sensors, or initialization instructions based at least in part on the system objectives.

24. The guidance system of claim 22, wherein the learning-rooted IoT system comprises a plurality of plug-and-play base pad apparatuses according to claim 1.

25. The guidance system of claim 22, wherein the one or more AI models and one or more parameters are further determined based at least in part on user input received via client computing device.

26. The guidance system of claim 22, wherein the one or more AI models comprise one or more of pre-trained models or user-provided models.

27. The guidance system of claim 22, wherein the one or more parameters comprise one or more of online learning options, human-in-the-loop settings, training dataset configurations, load sharing, hardware realization options, software realization options, or coordinated AI options.

28. A reconfigurable smart body patch, comprising:
a first layer comprising adhesive for connecting the reconfigurable smart body patch to a skin or clothing surface associated with a subject;
a bottom layer situated atop the first layer, the bottom layer comprising a first surface and a second surface, wherein the first surface comprises a battery; and
a top layer situated atop the second surface of the bottom layer, wherein the top layer comprises a plurality of hardware components configured to collect and process sensor data associated with movements and positions of the subject.

29. The reconfigurable smart body patch of claim 28, wherein the first layer, the bottom layer, and the top layer are flexible.

30. The reconfigurable smart body patch of claim 28, wherein the plurality of hardware components comprise one or more of a power management unit (PMU), microcontroller, components with uniform interfaces (CUIs), or a notification LED array.

31. The reconfigurable smart body patch of claim 30, wherein each CUI is associated with a peripheral device.

32. The reconfigurable smart body patch of claim 31, wherein a peripheral device comprises one or more of a sensor, an actuator, or a transducer.

33. The reconfigurable smart body patch of claim 32, further comprising a power converter for shifting an input voltage to a correct voltage for the peripheral device.

34. The reconfigurable smart body patch of claim 32, wherein a peripheral device is configured to collect one or more of distance data, acceleration data, rotation data, or action time data.

35. The reconfigurable smart body patch of claim 34, further comprising a peripheral controller configured to manages and collects data from the peripheral device communicate the data to the microcontroller.

36. The reconfigurable smart body patch of claim 30, wherein the microcontroller is configured to collect sensor data from each CUI.

37. The reconfigurable smart body patch of claim 30, wherein the microcontroller is configured to communicate with a remote computing device.

38. The reconfigurable smart body patch of claim 30, wherein the power management unit (PMU) connects to the battery to power components of the reconfigurable smart body patch.
